(19) United States
(12) Patent Application Publication
(10) Pub. No.: US 2026/0059402 A1
(43) Pub. Date: Feb. 26, 2026

(54) SYSTEM AND METHODS FOR IMPLEMENTING LOWER LAYER TRIGGERED MOBILITY (LTM) IN NEXT GENERATION BASE STATION

(71) Applicant: Samsung Electronics Co., Ltd., Suwon-si (KR)

(72) Inventors: Aby Kanneath ABRAHAM, Bangalore (IN); Joby MANUEL, Bangalore (IN)

(21) Appl. No.: 19/372,904

(22) Filed: Oct. 29, 2025

Related U.S. Application Data
(63) Continuation of application No. PCT/KR2024/008634, filed on Jun. 21, 2024.

(30) Foreign Application Priority Data
Jun. 23, 2023 (IN) 202341042045
Jun. 14, 2024 (IN) 2023 41042045

(51) Int. Cl. H04W 36/00; H04W 36/08

(52) U.S. Cl. CPC H04W 36/00835; H04W 36/0072; H04W 36/087

(57) ABSTRACT

The present disclosure describes a system and a method (1200) for implementing LTM when performing a cell switch procedure of a UE (122) from source cell (118) to target cell (120). The method comprises identifying a target cell for LTM for the UE (122) based on LTM measurements received from the UE and thereafter performing admission control on the target cell. The method further comprises generating, LTM configuration, when the admission control is successful. The method further comprises transmitting the generated LTM configuration to the UE in a RRC reconfiguration message. The method further comprises facilitating early synchronization of the UE (122) in the target cell (120) based on an F1AP message received from a target DU (204). The method further comprises performing an LTM cell switch completion upon receiving an indication from the target DU (204) indicating that an access to the target cell (120) is successful or not.

### FIELD OF TECHNOLOGY

The present invention relates to field of wireless communication. In particular, the present invention relates to a system and a method for implementing Lower Layer Triggered Mobility (LTM) in Next Generation Base station (gNB).

### BACKGROUND

The Fifth Generation (5G) New Radio (NR) is a wireless communication standard for fifth generation mobile networks (5G). In 5G NR, user equipment (UEs) can move across different cells in connected state, this process of ensuring seamless connectivity and continuity of service is known as mobility or handover. The NR standard supports different types of handover. The basic handover in NR consists of three steps: handover preparation, handover execution and handover completion. In the preparation stage, the base station (gNB) may configure the UE to report measurements and based on the reported measurements or based on its own understanding of the network topology, gNB sends Radio Resource Control (RRC) Reconfiguration message to handover the UE to another cell called the target cell, from the source cell. During execution, UE applies target cell configuration and accesses the target cell and during completion step, UE sends RRC Reconfiguration complete message. In an alternative approach, a handover is implemented by configuring the UE with the execution conditions (and not target cell configurations) for triggering handover and once the execution conditions are satisfied, the UE may move to target cell and send the RRC Reconfiguration complete.

However, in the existing handover methods known as Layer 3 Mobility, the gNB configures the UE with layer 3 measurements and uses these measurements to prepare the candidates/target cells and subsequently sends a cell switch command to the UE. This sending of layer 3 messages by UE causes considerable signalling overhead and latency issues.

Thus, there exists a need to overcome the above-mentioned limitations of the current technology and provide technique(s) for implementing LTM in gNB in an efficient manner.

### SUMMARY

The present disclosure describes a system and a method for implementing LTM in gNB. In the present disclosure, methods for implementing LTM in gNB for intra-gNB LTM are described. Further, embodiments for the implementation of Inter-DU and Intra-DU LTM are disclosed. Further, a number of steps related to the implementation of LTM in Centralized Unit (CU) and Distributed Unit (DU) are described. At step 1, reference configuration at CU is generated. At step 2, the admission control at CU and DU is described. At step 3, Early Sync at CU, source DU and candidate DU is implemented. Further, the timing Advance Management at DU is implemented. The present disclosure further describes interactions in various LTM scenarios at CU, source DU and candidate DU.

In one embodiment of the present disclosure, a method performed by a base station for implementing Lower Layers Triggered mobility (LTM) when performing a cell switch procedure of a User Equipment (UE) from a source cell to a target cell served by the base station, is disclosed. The method comprises identifying a target cell for LTM for the UE based on LTM measurements received from the UE or based on one or more internal decisions and thereafter performing admission control on the target cell based on one or more factors. The method further comprises generating LTM configuration when the admission control is successful. The method further comprises transmitting, the generated LTM configuration to the UE in a Radio Resource Control (RRC) reconfiguration message and to a source DU associated with the source cell. The method further comprises facilitating early synchronization of the UE in the target cell based on an F1AP message received from a target DU associated with the target cell. The method further comprises performing an LTM cell switch completion upon receiving an indication from the target DU indicating that an access to the target cell is successful.

In one of the embodiments, the LTM configuration comprises at least one of a complete LTM candidate configuration; and a non-complete LTM candidate configuration and an LTM reference configuration. The LTM reference configuration is based on at least one of a cell group configuration associated with the source cell and a cell group configuration associated with the target cell, along with a Layer 3 configuration associated with the CU. The Layer 3 configuration comprises a measurement configuration and a radio bearer configuration.

In one of the embodiments, the one or more factors comprise a number of UEs associated with a neighbor cell for which LTM is triggered, a number of RRC_CONNECTED UEs in the target cell, a number of UEs associated with the neighbor cell which are configured for a conditional handover. The performing the admission control on the target cell comprises performing one or more of: configuring the cell as LTM candidate cell when the number of UEs associated with the cell for which LTM is triggered is less than a first threshold; configuring the cell as LTM candidate cell when a sum of the number of RRC_CONNECTED UEs and the number of UEs associated with the cell for which LTM is triggered is less than a second threshold; and configuring the cell as LTM candidate cell when a sum of the number of RRC_CONNECTED UEs and. the number of UEs associated with the cell which are configured for the conditional handover and the number of UEs associated with the cell for which LTM is triggered is. less than a third threshold.

In one of the embodiments, facilitating the early synchronization of the UE in the target cell comprises: receiving by a Centralized Unit (CU) of the base station, from the target DU, the F1AP message comprising an LTM candidate cell identifier and a timing advance value; and transmitting the LTM candidate cell identifier and the timing advance value to the source DU associated with the source cell.

In one of the embodiments, the method comprises transmitting a Physical Downlink Control Channel (PDCCH) order for triggering or re-triggering the UE to perform early synchronization on the target cell, when the timing advance value is not communicated by the target DU to the source DU.

In one of the embodiments, the base station comprises a Centralized Unit (CU) and one or more DUs for serving the UE. The CU includes a centralized unit control-plane (CU-CP) and at least one centralized unit user-plane (CU-UP), and the one or more DUs comprise the source DU and the target DU which are coupled to the at least one CU-UP for serving the UE.

In one of the embodiments, the method further comprises performing operations of: receiving the LTM measurements from the UE. The LTM measurements comprise Layer 1 measurements comprising information associated with at least one of Reference signal received power (RSRP), Reference Signal Received Quality (RSRQ), and Signal-to-Interference-plus-Noise Ratio (SINR). The method further comprises based on determining that the received LTM measurements meet a first threshold, transmitting a Physical Downlink Control Channel (PDCCH) order comprising information regarding the target cell for triggering the UE to perform early synchronization on the target cell. The information regarding target cell comprises an LTM candidate cell index. The method further comprises, based on determining that the received LTM measurements meet a second threshold, transmitting a MAC Control Element (MAC CE) comprising information regarding the target cell for triggering the UE to perform cell switch, where the information regarding target cell comprises an LTM candidate cell index.

In one of the embodiments, based on identifying whether an early synchronization has occurred in the UE, initiating a timing advance (TA) timer; and upon receiving indication regarding the cell switch procedure, resetting the TA timer.

In one of the embodiments, the one or more internal decisions comprises one or more decisions made by the base station based on a deployment map or a load balancing. technique or prediction data received from one or more Machine Learning (ML) models. The RRC reconfiguration message to the source DU is transmitted in an F1 Application Protocol (F1AP) message.

In one of the embodiments, a base station for implementing Lower Layers Triggered mobility (LTM) when performing a cell switch procedure of a User Equipment (UE) from a source cell to a target cell served by the base station is disclosed. The base station is configured to identify a target cell for LTM for the UE based on LTM measurements received from the UE or based on one or more internal decisions. The base station is further configured to perform admission control on the target cell based on one or more factors. The base station is further configured to generate LTM configuration, when the admission control is successful. The base station is further configured to transmit the generated LTM configuration to the UE in a Radio Resource Control (RRC) reconfiguration message and to a source DU associated with the source cell. The base station is further configured to facilitate early synchronization of the UE in the target cell based on an F1AP message received from a target DU associated with the target cell and perform an LTM cell switch completion upon receiving an indication from the target DU indicating that an access to the target cell is successful.

### BRIEF DESCRIPTION OF THE DRAWINGS

Further aspects and advantages of the present disclosure will be readily understood from the following detailed description with reference to the accompanying drawings.

FIG. 1 shows a block diagram 100 illustrating NG-RAN Architecture in accordance with the embodiments of the present disclosure.

FIG. 2 shows an exemplary sequence diagram 200 illustrating overall flow of LTM in accordance with the embodiments of the present disclosure.

FIG. 3A-3D show flow charts illustrating admission control in LTM, in accordance with some embodiments of the present disclosure.

FIG. 4 shows a sequence diagram 400 illustrating generation of LTM configuration in accordance with the embodiments of the present disclosure.

FIG. 5A-5F show sequence diagrams illustrating Early Sync Random Access Channel (RACH) in LTM in accordance with the embodiments of the present disclosure.

FIG. 6 illustrates a sequence diagram 600 illustrating determination of Downlink/Uplink Bandwidth Part (DL/UL BWP) for LTM, in accordance with some embodiments of the present disclosure.

FIG. 7 illustrates. a. sequence diagram 700 illustrating RRC Connection Reestablishment/Radio Link Failure (RLF) handling with LTM, in accordance with some embodiments of the present disclosure.

FIG. 8A shows a sequence diagram illustrating a scenario for Handling F1 Application Protocol (F1AP) Reset during LTM, in accordance with some embodiments of the present disclosure.

FIG. 8B shows a sequence diagram illustrating a scenario for Handling E1AP Reset during LTM, in accordance with some embodiments of the present disclosure.

FIG. 9 illustrates a sequence diagram 900 illustrating Handling Bearer Modification Failure during LTM, in accordance with some embodiments of the present disclosure.

FIG. 10 illustrates a sequence diagram 1000 illustrating a first scenario for Early Sync RACH, in accordance with some embodiments of the present disclosure.

FIG. 11 illustrates a sequence diagram 1100 illustrating a second scenario for Early Sync RACH, in accordance with some embodiments of the present disclosure.

FIG. 12 illustrates a flow chart 1200 illustrating a method for implementing LTM when performing a cell switch procedure, in accordance with some embodiments of the present disclosure.

FIG. 13 illustrates an exemplary sequence diagram 1300 illustrating a basic flow of LTM, in accordance with the embodiments of the present disclosure.

FIG. 14 illustrates a sequence diagram 1400 illustrating a third scenario for Early Sync RACH similar to FIGS. 5C, 10-11, in accordance with some embodiments of the present disclosure.

FIG. 15 illustrates a sequence diagram 1500 illustrating a fourth scenario for Early Sync RACH similar to FIG. 14, in accordance with some embodiments of the present disclosure.

FIG. 16 illustrates a sequence diagram 1600 illustrating a fifth scenario for Early Sync RACH similar to FIG. 15, in accordance with some embodiments of the present disclosure.

FIG. 17 shows a sequence diagram 1700 illustrating a scenario for Handling E1 Reset during LTM similar to FIGS. 8A-8B, in accordance with some embodiments of the present disclosure.

FIG. 18 shows a sequence diagram 1800 illustrating a scenario of Early Sync Random Access Channel (RACH) in LTM similar to that illustrated in FIG. 5C, in accordance with the embodiments of the present disclosure.

### DETAILED DESCRIPTION

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus preceded by “comprises. . . a” does not, without more constraints, preclude the existence of other elements or additional elements in the system.

The terms like “at least one” and “one or more” may be used interchangeably throughout the description. The terms like “a plurality of” and “multiple” may be used interchangeably throughout the description. The terms like “distributed unit”, “distributed unit entity” and “DU” may be used interchangeably throughout the description. The terms like “central unit control plane”, “CU-CP” and “CU-CP entity”, may be used interchangeably throughout the description. The terms like “central unit user plane”, “CU-UP” and “CU-UP entity” may be used interchangeably throughout the description. The terms like “L1/L2 triggered mobility” and “LTM” may be used interchangeably throughout the description. The terms like “Timing Advance” and “TA” may be used interchangeably throughout the description. The terms like “Early Sync” and “Early Synchronization” may be used interchangeably throughout the description. The terms “cell switch”, “serving cell change”, “mobility” and “handover” may be used interchangeably throughout the description. The terms like “candidate gNB-DU” and “target gNB-DU” may be used interchangeably throughout the description. The terms like “candidate cell” and “target cell” may be used interchangeably throughout the description. It is to be appreciated that the interchangeable terms disclosed in foregoing paragraphs may be used repeatedly throughout the disclosure. However, the same shall not be construed limiting the scope of the present disclosure in any sense.

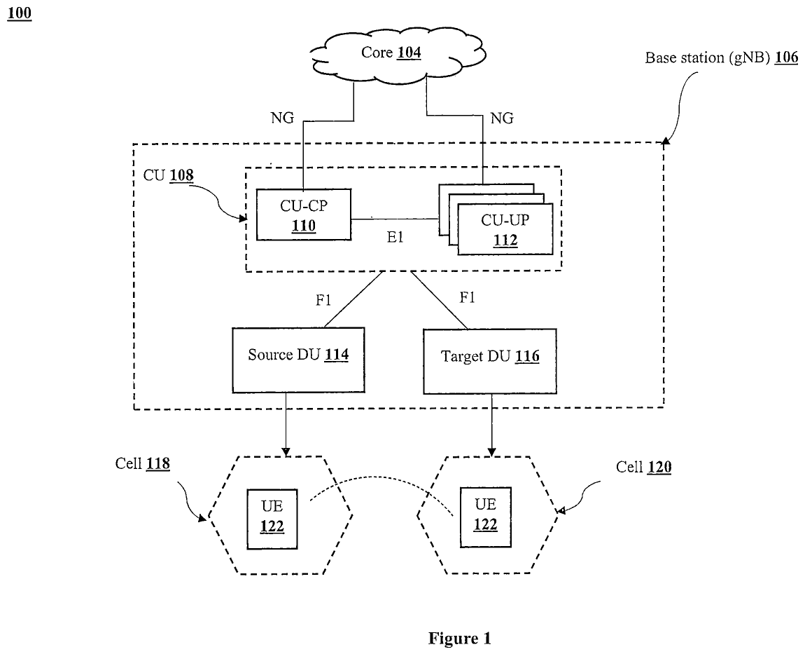

FIG. 1 shows a block diagram 100 illustrating NG-RAN Architecture or a communication system (also referred to as a “system”), in accordance with the embodiments of the present disclosure. The NG-RAN architecture consists at least one Next Generation Base station (gNB) 106 connected to the 5G Core network 104 through the NG interface. In one embodiment, there can be plurality of gNBs, that may be interconnected through Xn interfaces. Further, the gNB 106 consists of a control/centralized unit (CU) 108 and one or more distributed units (DUs) 114, 116. In one configuration, the CU 108 is configured to serve the DUs 114, 116 and the DUs 114, 116 are configured to serve the one or more UEs 122 via one or more cells. The CU 108 and DUs 114, 116 are connected via F1 interface. Further, the CU 108 comprises a centralized unit control plane (CU-CP) 110 and one or more centralized unit user plane (CU-UP) 112 that handle the control-plane and user-plane processing of the CU 108, respectively. The one or more CU-UPs may comprise at least one source CU-UP 112a and a target CU-UP 112b each (not shown in Figure) The CU-CP 110 is communicatively coupled with each of the CU-UPs 112 via an El interface. The CU-CP 110 is communicatively coupled with each of the DUs 114, 116 and via an F1-C interface. Each of the DUs 114, 116 may be communicatively coupled to each of the CU-UPs via an F1-U interface. The CU-CP hosts the Packet Data Convergence Protocol (PDCP) and Radio Resource Control (RRC) layers, while the DU hosts the Radio link Control (RLC)/Media Access Control (MAC) and Physical (PHY) layers. The DU 114 serving the UE 122 present in the source cell 118 may be referred as source DU 114 and the DU 116 serving the UE 122 present in the target cell 120 may be referred as target or candidate DU 114. The UE 122 may be communicatively coupled to at least one DU 114 or 116, which is serving it via a fronthaul network depending on the cell the UE 122 is stationed in. In an embodiment, the fronthaul network which may comprise a private network, and/or the Internet, but not limited thereto. The CU, DU, CU-UP, CU-CP may be logical entities, i.e., they may be collocated in the same hardware and may be differentiated through software. The embodiments of CU, DU, CU-UP, CU-CP may mean that of any node or entity which performs the functionalities of CU, DU, CU-UP, CU-CP as described in 3gpp specifications.

As shown in FIG. 1, the architecture of gNB 106 shows that the DU 114 and DU 116 have respective cell coverage defined by cells 118 and 120, respectively. The inter gNB-DU mobility may be defined as cell switch of the UE 122 between cells 118 and 120 of different gNB DUs 114 and 116. In another embodiment, the intra gNB-DU mobility may be defined as cell switch of the UE 122 from one cell 118 to another cell 120 of the same DU 114.

When the UE 122 moves from one cell: 118 to another cell 120, i.e., a source cell to a target cell, a serving cell change operation is triggered. In L3 mobility, the serving cell change is performed by RRC signaling triggered reconfiguration which causes longer latency, larger overhead, and longer interruption time. With 3GPP release 18, new mechanism and procedures of L1/L2 based inter-cell mobility for reduced mobility latency are introduced. The L1/L2 triggered mobility (LTM) enables a serving cell change via L1/L2 signaling. The LTM is fundamentally different from the conventional Layer 3 Mobility. Here, the UE 122 may dynamically perform a cell switch procedure to the cell 120. In LTM, the enabling of serving cell change via L1/L2 signalling, minimizes the latency, overhead and interruption time. Further the gNB 106 may configure the UE 122 with multiple candidate cells 120 to allow fast application of configurations for candidate cells 120. Thus, LTM is basically triggered based on L1 measurements rather than L3 measurements. Further, LTM is performed without reset of lower layers like MAC to avoid data loss and to further reduce the additional delay caused in recovery of data.

LTM is a procedure in which the gNB 106 receives L1 measurement reports from UEs 122. On the basis of the L1 measurements, the gNB 106 changes UE's 122 serving cell(s) 120 through MAC CE. The gNB 106 also may change the UE's serving cells through MAC CE based on its internal algorithms or factors, for e.g. based on its internal understanding of the deployment map or based on the load balancing or based on predictions from its AI models. These factors are also known as internal decisions that aids the gNB 106 to identify a candidate/target cell. The gNB 106 prepares one or multiple candidate cells 120 and provides the candidate cell configurations to the UE 122 through RRC reconfiguration message. Then LTM cell switch is triggered, by selecting one of the candidate configurations as target configuration for LTM by the gNB 106. The candidate cell configurations can only be: added, modified, and released by network via RRC signaling.

LTM supports both intra-gNB-DU, intra-gNB-CU, and inter-gNB-DU mobility. FIG. 1 describes the scenario of inter-gNB-DU mobility, where the mobility occurs between the source DU 114 and the target DU 116.

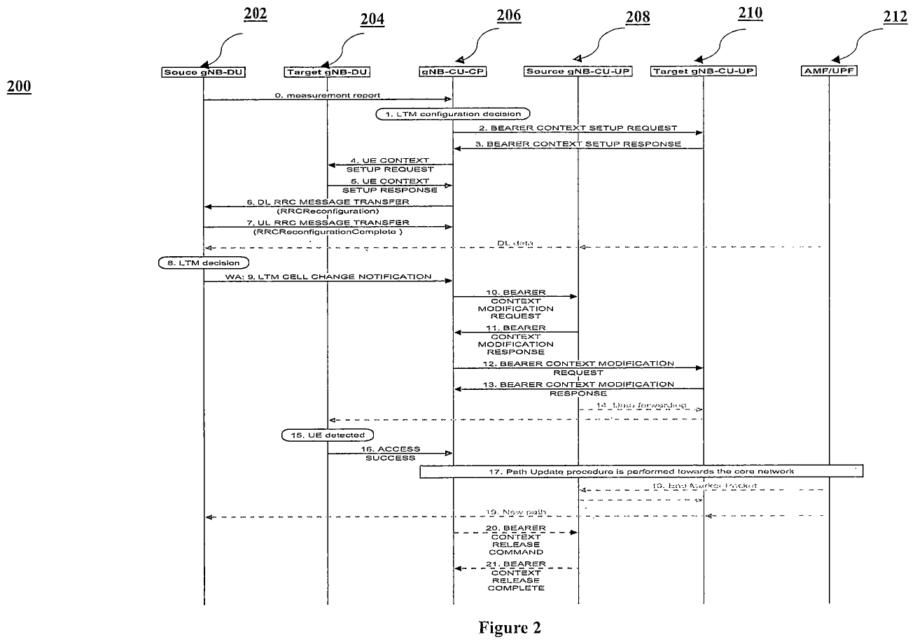

FIG. 2 shows an exemplary sequence diagram 200 illustrating overall flow of LTM in accordance with the embodiments of the present disclosure.

It is to be noted that the process disclosed in the steps 0-21 of FIG. 2 (in foregoing paragraphs) provides the exchange of signaling and information between various entities of the gNB 106 such as a source DU 202, a target DU 204, a CU-CP 206, a source CU-UP 208, a target CU-UP 210, and an access management function (AMF) 212. The source DU 202 is same source DU 114 as illustrated in FIG. 1. The target DU 204 is same target DU 116 as illustrated in FIG. 1. The CU-CP 206 is same CU-CP 110 as illustrated in FIG. 1. The one or more CU-UPs 112a and 112b of FIG. 1 may be same as the source-CU-UP 208 and the target-CU-UP 210 of FIG. 2. Typically, the procedure for LTM may be partitioned into 4 phases: 1) LTM preparation, 2) Early Synchronization 3) LTM execution, and 4) LTM completion. Initially, the UE 122 sends a Measurement Report to the gNB 106 (specifically, to the source DU 202 of the gNB). In one of the embodiments, measurement report is the L1 Reference signal received power (RSRP) measurements that may be or may not be filtered. As shown in FIG. 2 of the present disclosure, at step 0, the source DU 202 is configured to send the measurement report received from UE 122 to the CU-CP 206. In particular, the source DU 202 configures the UE 122 measurement procedures and the UE reports according to the measurement configuration. At step 1, an LTM configuration decision is made by the CU-CP 206 based on the measurement report, i.e., the CU-CP 206 decides to configure the UE for LTM the UE 122, based on the UE reports. Based on the LTM configuration decision, in steps 2 and 3, a bearer context setup request is sent from the CU-CP 206 to the target CU-UP 210 and thereafter a corresponding response is received from the target CU-UP 210 by the CU-CP 206. At step 4 and 5, the CU-CP 206 transmits a UE context setup request to the target DU 204 and thereafter a corresponding response is received by the CU-CP 206 from the target DU 204. At step 6, the CU-CP 206 may provide LTM Candidate Configuration, i.e., configure LTM candidate cells through one RRC Reconfiguration message for the target cell 120 to the UE. In an embodiment, the CU-CP 206 may further release or modify the candidate configurations. In another embodiment, the UE 122 may store the LTM configuration of other candidate cells even after moving to the candidate cell 120 through LTM. At step 6, the CU-CP 206 may also provide the UE, via the source DU 202, the configuration for performing LTM measurements for different candidate frequencies and candidate cells and reporting based on the performed LTM measurements.

In a typical LTM candidate preparation phase, the gNB 106 transmits an RRC Reconfiguration message to the UE 122 in order to initiate LTM, i.e., the gNB 106 configuration provides of one or multiple LTM candidate target cells. Further, the UE 122 stores the configuration of LTM candidate target cell(s) and transmits the RRC Reconfiguration Complete message to the gNB 106. The transfer RRC Reconfiguration Complete message by the source DU 202 to the CU-CP 206 is depicted in step 7.

Post making the LTM decision of cell switch at step 8, the source DU 202 instructs the UE 122 to switch to the LTM candidate cell. UE 122 switches to the LTM candidate target cell 120. Source DU may notify an LTM cell change notification to the CU-CP 206. Based on the LTM cell decision, in steps 10 and 11, a bearer context modification request is sent from the CU-CP 206 to the source CU-UP 208 and thereafter a corresponding response is received from the source CU-UP 208 by the CU-CP 206. At steps 12 and 13, bearer context modification request is sent from the CU-CP 206 to the target CU-UP 210 and thereafter a corresponding response is received from the target CU-UP 210 by the CU-CP 206. At step 15, the target DU 204 detects the UE 122 and at step 17, the target DU 204 transmits an access success notification to the CU-CP 206. At step 17, a path update procedure is performed towards the core network 104 and thereafter at step 18, an end marker packet is transmitted by the AMF 212 to the source CU-UP 208 and a new path is created at step 19. Finally, at steps 20 and 21, a bearer context release request is sent from the CU-CP 206 to the source CU-UP 208 and thereafter a corresponding response is received from the source CU-UP 208 by the CU-CP 206.

In an embodiment, the CU-CP 206 buffers any Non-Access stratum (NAS) message received between being informed by the source DU 202 about LTM Cell Switch Initiation (reception of message in step 9 of FIG. 2) and the successful completion of LTM cell switch (reception of Access Success as in step 16 of FIG. 2 or reception of RRC Reconfiguration complete etc.) and sends to the new Primary Cell (PCell) after the LTM is successfully completed.

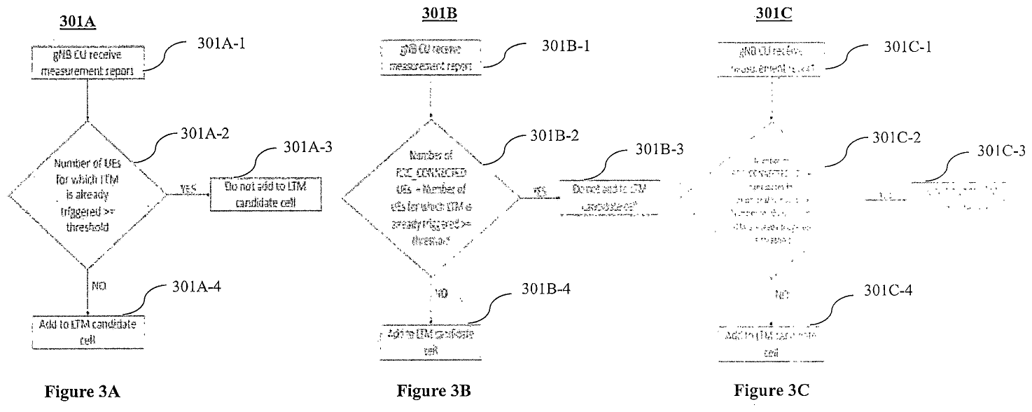

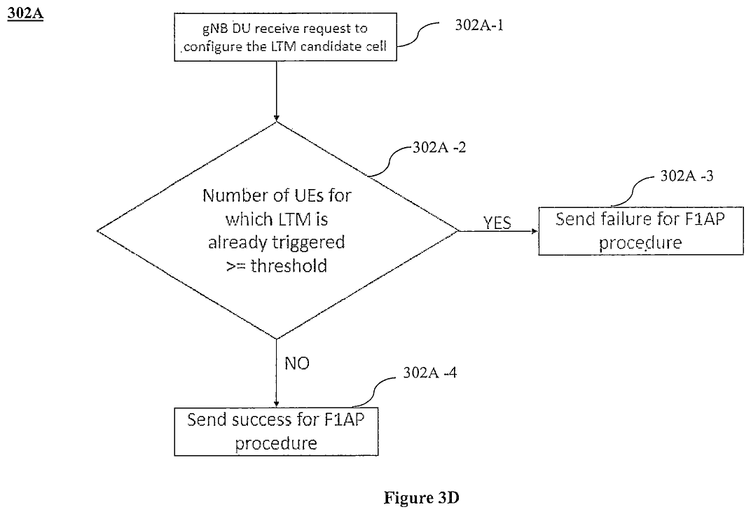

FIG. 3A-3D show flow charts illustrating admission control in LTM, in accordance with some embodiments of the present disclosure.

Before proceeding with the cell switch procedure, the gNB 106 must ensure whether the target cell is capable of being configured for LTM. Admission control is a major step during setting up of the UE 122 in the gNB, for the target cell 120. Thus, the admission control has a direct dependency on the total number of such UEs in the source 118 as well as candidate or target cell 120.

FIG. 3A shows a flow chart 301-A illustrating a first scenario of admission control in LTM by the CU 108 (and specifically by the CU-CP 110 or 206). To ensure admission control, the CU 108 maintains a list of all the UEs to which LTM candidate cells are configured. Further, the CU 108 maintains a threshold of the number of UEs per candidate cell that can be configured as LTM candidate cell. At step 301A-1, the CU 108 receives the measurement report or determines to do LTM configuration based on one or more internal factors. Thereafter CU 108 determines at step 301A-2, whether the number of UEs for which LTM is triggered is equal to greater than a threshold, if the condition is met, at step 301A-3, the CU 108 doesn't configure the cell as LTM candidate cell for the UE. If the number of UEs for which LTM is triggered is less than the threshold, at step 301A-4, the CU 108 configures the cell as LTM candidate cell to the UE.

FIG. 3B shows a flow chart 301B illustrating a second scenario of admission control in LTM by the CU 108 (and specifically by the CU-CP 110 or 206). The CU 108 considers the number of UEs already in the candidate cell 120 (i.e., number of RRC_CONNECTED UEs in the cell) along with the number of UEs as the LTM candidate cells during admission control. At step 301B-1, the CU 108 receives the measurement report or determines to do LTM configuration based on one or more internal factors. Thereafter CU 108 determines at step 301B-2, whether the total number of UEs in the cell (RRC_CONNECTED UEs) and the total number of LTM candidate cell is greater (or alternatively equal to) than a threshold value, if the condition is met, at step 301B-3, CU 108 may not configure a cell as LTM candidate cell, else at step 301B-4, the CU 108 configures a cell as LTM candidate cell.

FIG. 3C shows a flow chart 301C illustrating a third scenario of admission control in LTM by the CU 108 (and specifically by the CU-CP 110 or 206). The CU 108 considers the number of UEs already in the candidate cell 120 (i.e., number of RRC_CONNECTED UEs in the cell) and the number of UEs which are configured as candidates for conditional handover along with the number of UEs as the LTM candidate cells during admission control. At step 301C-1, the CU 108 receives the measurement report or determines to do LTM configuration based on one or more internal factors. Thereafter CU 108 determines at step 301C-2 whether the total number of UEs in the cell (RRC_CONNECTED UEs), number of UEs which are configured with the same cell as candidates for conditional handover and the total number of UE's which are configured with the same LTM candidate cell is above (or alternatively equal to) a threshold value, if the condition is met, at step 301C-3, CU 108 may not configure a cell as LTM candidate cell, else at step 301C-4, CU 108 configures a cell as LTM candidate cell.

FIG. 3D shows a flow chart 302A-1 illustrating admission control in LTM by a target/candidate DU 204. In an embodiment the target/candidate DU 204 maintains the list of all the UEs to which LTM candidate cells are configured. In an embodiment, the candidate DU 204 maintains a threshold of the number of UEs per candidate cell that can be configured as LTM candidate cell. Further, the CU-CP 206 sends F1AP UE Context Setup Request (for Intra-DU LTM) or F1AP UE Context Modification Request (for Inter-DU LTM) for configure the LTM candidate cell. At step 302A-1. the candidate DU 204 receives a request to configure the LTM candidate cell and thereafter determines at step. 302A-2 whether the number of UEs for which LTM is triggered is equal to or greater than the threshold, if the condition is met, at step 302A-3 the target/candidate DU 204 doesn't configure the cell as LTM candidate cell to the UE 122 and sends back failure for F1AP UE Context Setup procedure or F1AP UE Context Modification procedure. If it can accept the LTM candidate cell, at step 302A-4 the target/candidate DU 204 sends successful response for F1AP UE Context Setup procedure or F1AP UE Context Modification procedure. In an embodiment, while sending the successful response, the target/candidate DU 204 may include RACH configuration for early sync in F1AP UE Context Setup Response or F1AP UE Context Modification Response.

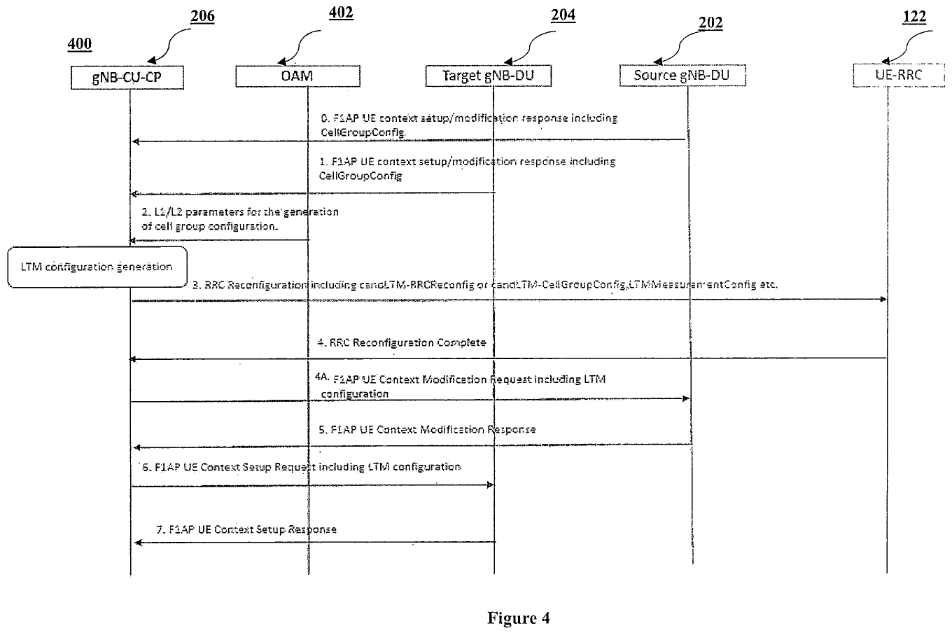

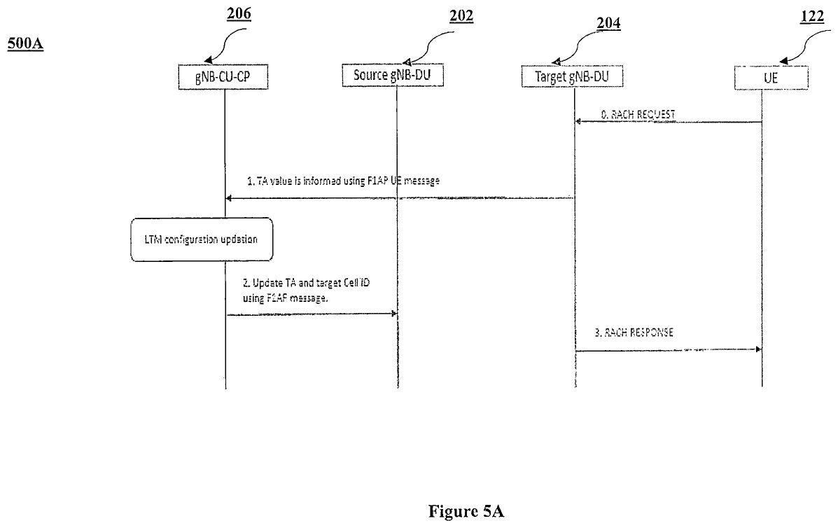

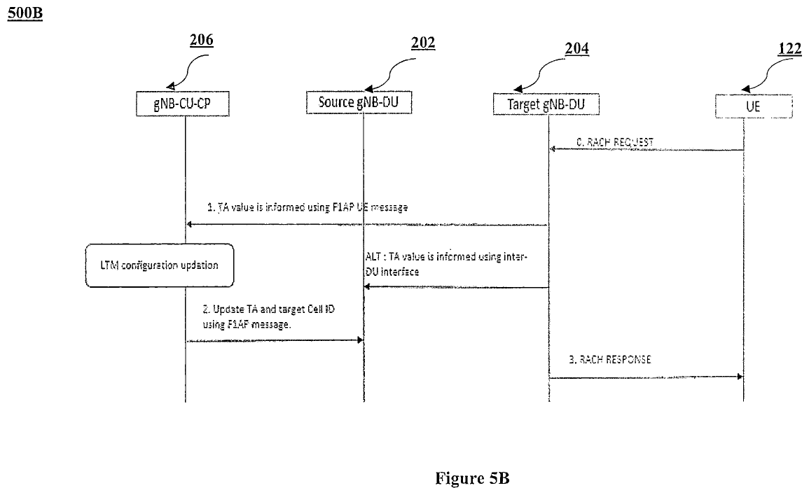

FIG. 4 shows a sequence diagram 400 illustrating generation of LTM configuration in accordance with the embodiments of the present disclosure. It is to be noted that the process disclosed in the steps 0-7 of FIG. 4 (in foregoing paragraphs) provides the exchange of signaling and information between the source DU 202, the target DU 204, the CU-CP 206, the UE 122 and an Operations, Administration and Maintenance (OAM) node 402.

Once the target cell is identified capable of serving UE, thereafter, the CU-CP 206 generates reference configuration. Further, LTM Candidate Configuration is provided to configure LTM candidate cells. Candidate cell configuration can be provided as delta configurations on top of the reference configuration, which form a complete candidate cell configuration. The reference configuration is managed separately, and the UE 122 stores the reference configuration as a separate configuration. The reference configuration can be empty. The complete candidate configuration is applied when the UE 122 receives the candidate cell configuration before reception of the LTM cell switch command. In one of the embodiment, the UE 122 is configured to apply complete candidate configuration when the UE 122 receives the candidate cell configuration after reception of the LTM cell switch command. The complete candidate cell configuration is applied and replacing the current UE configuration at the time of reconfiguration execution. Although the reconfiguration procedure makes replacement, it does not necessarily reset MAC, RLC, or PDCP layer.

The CU-CP 206 generates reference configuration by including the cell group configuration (for e.g., CellGroupConfig IE in NR) received from the current serving cell (i.e., received from the current DU (source DU) 202) in one of F1AP UE Context Setup or F1AP UE Context Modification procedures) and the layer 3 configurations such as measurement configuration, radio bearer configuration etc. generated by the CU-CP 206. This is illustrated in step 0 and 1 of FIG. 4. At step 0, the CU-CP 206 receives F1AP UE context setup/modification response including a cell group configuration from the source DU 202. At step 1, the CU-CP 206 receives F1AP UE context setup/modification response including a cell group configuration from the target DU 204.

The CU-CP 206 also generates the layer 3 configurations such as measurement configuration and radio bearer configuration and construct the reference configuration. This is illustrated in step 2 of FIG. 4. Thereafter, the CU-CP 206 sends the generated reference configuration to the source DU 202 over F1AP interface (Step 4 in FIG: 4) and the UE 122 in RRC reconfiguration message This is illustrated in step 3 of FIG. 4.

In another embodiment, the CU-CP 206 generates complete configuration for an LTM candidate cell by including L1/L2 parameters received from OAM 402. In another embodiment the candidate DU 204 transmits the CellGroupConfig for generation of complete configuration to the CU-CP 206 in F1AP UE Context Setup Response or F1AP UE Context Modification Response. The CU-CP 206 generates and includes L3 configuration. If the L3 configuration is LTM complete configuration, the CU-CP 206 includes signalling radio bearers 1 and 2 (SRB1) and (SRB2), at least one Data Radio Bearer (DRB) and a Multicast Radio Bearer (MRB) but excludes Security configuration in the LTM complete candidate configuration. (Step 4-7 of FIG. 4). If the CU-CP identifies that the candidate cell belongs to another base station, security configuration may be included.

If the LTM Reference Configuration IE is comprised within the Reference Configuration IE in the LTM Information Setup IE included in the UE CONTEXT SETUP REQUEST message, the source DU 202, if supported, takes it into account for generating the LTM lower layer configuration. If. the Request for Lower Layer Configuration IE set to “true” is contained within the Reference Configuration IE in the LTM Information Modify IE included in the UE CONTEXT MODIFICATION REQUEST message, the source DU 202, if supported, includes the CellGroupConfig IE in the UE CONTEXT MODIFICATION RESPONSE message to provide lower layer configuration for the CU-CP 206 to generate the LTM reference configuration.

In an embodiment, the CU-CP 206 releases the reference configuration and all LTM candidate cell configuration before sending Xn Handover (HO) request. In an embodiment, upon receiving Xn HO Request, target DU 204 instruct the UE 122 to release the reference configuration and all LTM candidate cell configuration.

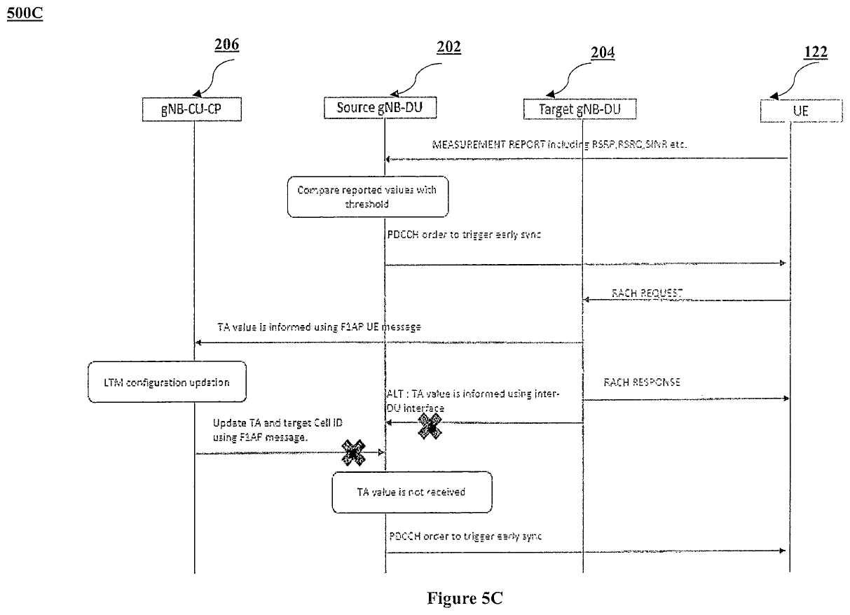

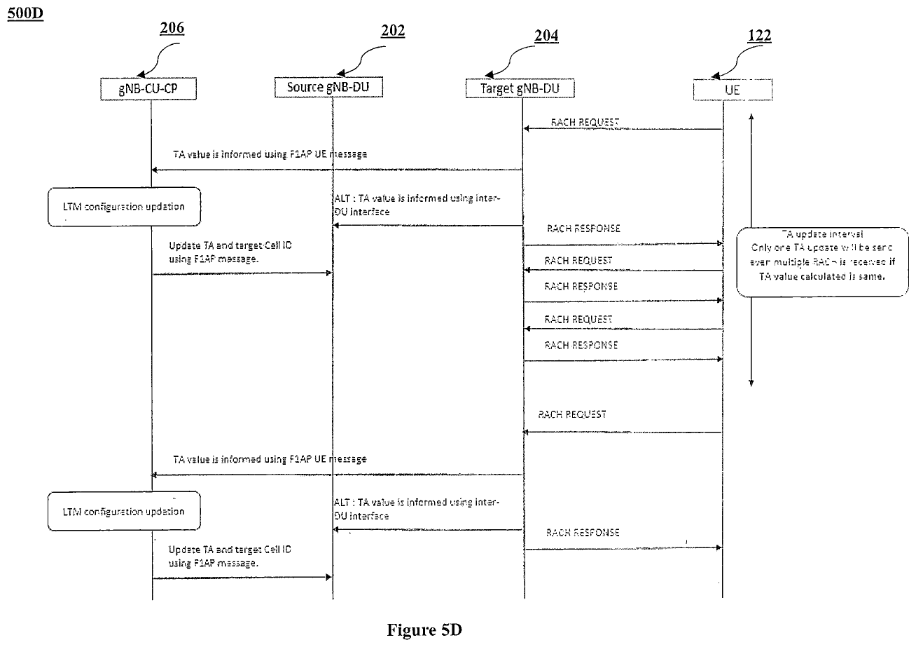

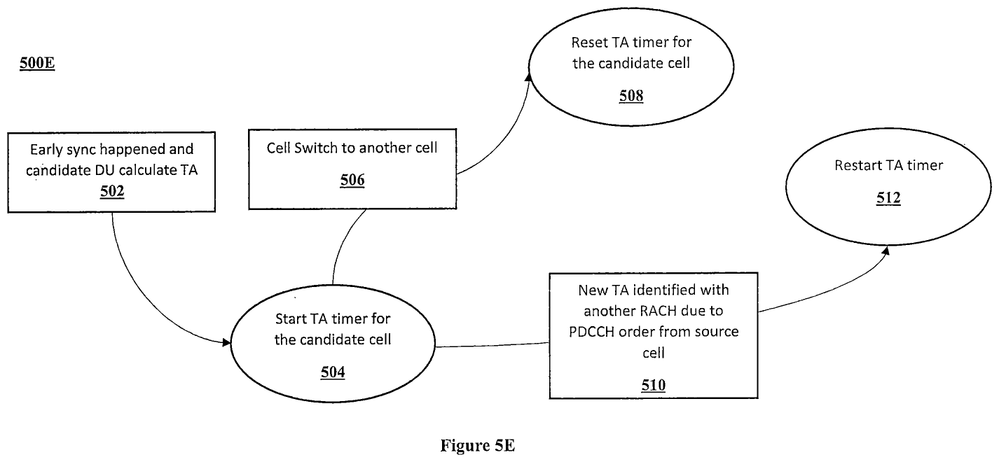

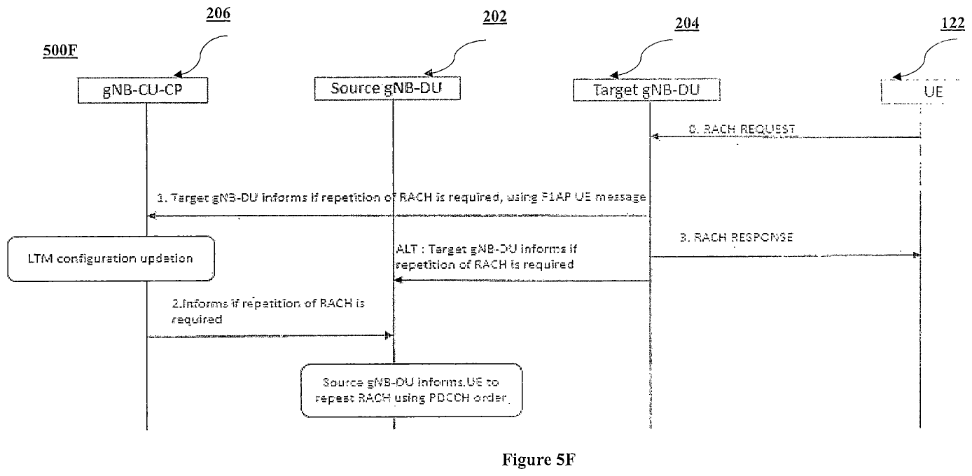

FIG. 5A-5F show sequence diagrams illustrating Early Sync Random Access Channel (RACH) in LTM in accordance with the embodiments of the present disclosure.

Post receiving the configuration information, in the Early Synchronization phase the UE 122 may perform DL synchronization and Timing Advance (TA) acquisition with candidate target cell(s) 120 before receiving the LTM cell switch command. In one configuration, the DL synchronization for candidate cell(s) 120 before cell switch command is supported, at least based on Synchronization Signal Block (SSB). In another configuration, TA acquisition of candidate cell(s) 120 before LTM cell switch command is supported, at least based on Physical Downlink Control Channel (PDCCH) ordered Random Access Channel (RACH), where the PDCCH order is only triggered by the source cell 118.

In the LTM execution phase, the UE 122 performs L1 measurements on the configured LTM candidate target cell(s) and transmits lower-layer measurements or measurement reports to the gNB 106. The lower-layer measurement or measurement reports are carried on L1 or MAC. In other words, the UE 122 performs the L1 measurements on the source cell 118 and candidate cell 120 and report L1 measurements through CSI reports to the source DU 202. In response the source DU 202 may send a MAC CE (for e.g., LTM MAC CE or LTM cell switch MAC CE) asking the UE 122 to switch to another cell which is an LTM candidate cell. Thereafter, the UE 122 may perform random access during LTM cell switch, or the cell switch may be RACH less.

In particular, the gNB 106 decides to execute LTM cell switch to the target cell 120 and transmits a MAC CE triggering LTM cell switch by including the candidate configuration index of the target cell 120. The UE 122 switches to the configuration of the LTM candidate target cell 120.

The UE 122 performs random access procedure towards the target cell, and in the LTM completion phase, the UE 122 simply indicates successful completion of the LTM cell switch towards the target cell 120. In one configuration, an uplink signal or message after the UE 122 has switched to the target cell 120 is used to indicate successful completion of the LTM cell switch.

In one embodiment, the UE 122 may be requested to perform random access on the candidate cell 120 before the cell switch, so that the network can calculate the timing advance before the cell switch and inform the UE 122 either through the random access response or within the MAC CE which is send for the cell switch.

The UE 122 may be requested ordered to perform random access on the candidate cell 120 before the cell switch, so that the gNB 106 can calculate the timing advance before the cell switch and inform the UE 122 either through the random access response or within the MAC CE which is send for the cell switch. When the Random Access procedure is initiated, the UE 122 selects a set of Random Access resources and initialises the following parameters for the Random Access procedure according to the values configured by RRC for the selected set of Random Access resources: RACH preamble is one such random Access resource. The gNB 106 may configure the UE 122 to perform random access towards one or more LTM candidate cells for receiving the timing advance (TA) before the cell switch is performed (known as Early TA or Early Sync TA or TA for Early Sync). Random access performed on LTM candidate cells for the timing advance reception may be referred to as Random access for early TA. The gNB 106 sends a Physical Downlink Control Channel (PDCCH) order to initiate RACH for TA measurement for candidate cells. The UE 122 receives PDCCH order from the serving cell 118. The Random Access procedure on an LTM candidate cell may only be initiated by the PDCCH order. Upon reception of this PDCCH order, UE 122 initiates RACH for TA measurement for candidate cells on the one or more candidate cell. At step 0 of FIG. 5A, a RACH request is sent, by UE 122 to the target DU 204. In other words. the UE 122 sends RACH preamble to the candidate cells and receives the Timing Advance (TA) value from the candidate cell. At step 1 of FIG. 5A, this TA value is transmitted from the target DU 204 to the CU-CP 206 by an F1AP message. At step 2 of FIG. 5A, an updated TA value and a target cell ID is transmitted from CU-CP 206 to the source DU 202 by an F1AP message. TA for candidate cells may be received from the source cell 118 also. TA may be received in the random access response or it may be also received through the MAC CE. gNB 106 may include TA in the cell switch command. If the source DU 202 indicates the UE 122 to retransmit the RACH for early TA, the UE 122 retransmits the same. gNB 106 may also send PDCCH order to retransmit RACH for TA measurement (also known as RACH for early sync).

In other words, at step 1, when the UE 122 performs random access for Early Sync in an LTM candidate cell, the candidate DU 204 informs CU-CP 206 the Timing Advance through F1AP message. The candidate DU 204 includes the LTM candidate cell identifier and the calculated Timing Advance in F1AP message. At step 2, the CU-CP 206 also informs the received candidate cell identifier and the corresponding Timing Advance to the source DU 202 through an F1AP message.

In an alternative embodiment, upon receiving the random access preamble for early sync from the UE 122 (step 0 of FIG. 5B), the candidate DU 204 informs the source DU 202 the candidate cell information such as candidate cell index and the timing advance through an inter-DU interface. In other words, the source DU 202 receives the Timing Advance for the UE 122 for the candidate cells from the candidate DU 204, once. the UE 122 performs early Sync on the candidate cell 120. (Step 2 in FIG: 5B)

In an embodiment; upon receiving the random access preamble for early sync from the UE 122, the candidate DU 204 informs the CU-CP 206, the candidate cell information such as candidate cell index and the timing advance and the CU-CP 206 informs the same to the source DU 202 through an F1AP message.

In an embodiment, the candidate DU 204 might receive multiple random access preamble for early sync from the same UE 122 for the same candidate cell, but it informs the CU-CP 206 or the source DU 202 only once through F1AP message or Inter-DU communication, respectively.

In an embodiment, if the candidate DU 204 receive multiple random access preamble for early sync from the same UE 122 for the same candidate cell and the calculated timing advance value of a later attempt is different from the value of the timing advance it has informed the CU-CP 206 or the source DU 202 earlier. The candidate DU 204 again informs the CU-CP 206 or the source DU 202 again by sending another F1AP message or Inter-DU message.

In an embodiment as illustrated in FIG. 5C, post receiving the measurement report from UE 122, the reported values are compared with a first threshold, and PDDCH order to trigger early sync is transmitted to UE 122 based on the comparison. Further, the source DU 202 repeats PDCCH order if it has not received timing advance from CU-CP 206 or the target DU 204 within a certain time interval. The source DU 202 sends the PDCCH order to the UE 122 for performing early sync TA and indicates that the PDCCH order is for a retransmission.

In an embodiment, source DU 202 repeats PDCCH order if it has not received timing advance from CU-CP 206 or the target DU 204 in all scenarios.

In an embodiment, the source DU 202 receives information from Operations, Administration and Maintenance (OAM) 402, CU-CP 206 or the target DU 204 whether the UE 122 needs to repeat the RACH preamble for early access. Based on the received information, the source DU 202 sends the PDCCH order informing the UE 122 whether to repeat the RACH preamble for early access.

As illustrated in FIG. 5D, the candidate DU 204 might receive multiple random access preamble for early sync from the same UE 122 for the same candidate cell within an interval, but it informs the CU-CP 206 or the source DU 202 only once through F1AP message or. Inter-DU communication, respectively. If the candidate DU 204 receive a random access preamble for early sync from the same UE 122 outside this interval it may send F1AP message or Inter-DU communication to the CU-CP 206 or the source DU 202 respectively, including the candidate cell information (such as candidate cell index) and the timing advance value.

In FIG. 5E, at step 502, once the candidate DU 204 has identified the timing advance for the candidate cell 120 based on the received random access preamble for early sync, at step 504 it starts a timer for the timing advance. The timer is kept running after the UE 122 performs successful cell switch to the candidate cell and upon expiry of this timer, the candidate DU 204 informs the UE 122 the Timing Advance through the MAC CE.

In an embodiment, if the candidate DU 204 identifies that the cell switch happened on another cell (for e.g., if it receives an indication from the CU-CP 206 that the cell switch happened on another cell or if it identifies that the cell switch is on another candidate cell of the same DU etc.), the candidate DU 204 resets this timer at step 506.

In an embodiment, if the candidate DU 204 identifies that the cell switch happened on another cell (for e.g. if it receives an indication from CU-CP 206 that the cell switch happened on another cell or if it identifies that the cell switch is on another candidate cell of the same DU etc.), candidate DU 204 keeps this timer running and if the timer expires while the UE 122 is connected on another cell, candidate DU 204 doesn't restart the timer.

In an embodiment, at step 510, if the candidate DU 204 receives another random access preamble for early access and it has identified a new timing advance value, (and has informed the CU-CP 206 or the source DU 202 for inter-DU case), at step 512 it restarts this timer.

In an embodiment as illustrated in FIG. 5F, the candidate DU 204 informs the CU-CP 206 if it prefers the repetition of random access preambles (step 2 of FIG. 5F) through an F1AP message such as F1AP UE Context Setup Response or F1AP UE. Context Modification Response or any other F1AP message.

In an alternative embodiment, the candidate DU 204 informs the source DU 202 if it prefers the repetition of random access preambles through an inter-DU message.

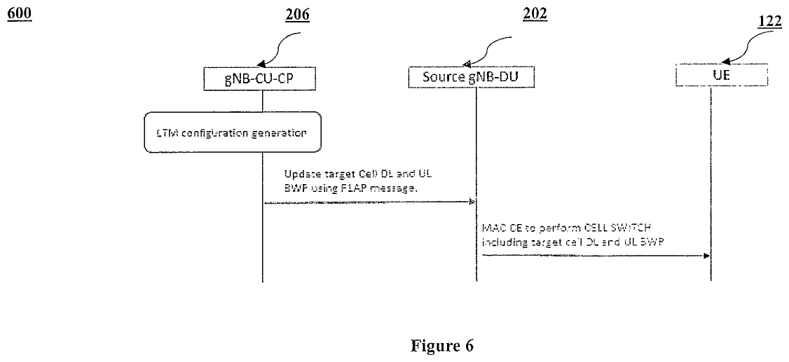

FIG. 6 illustrates a sequence diagram 600 illustrating determination of Downlink/Uplink Bandwidth Part (DL/UL BWP) for LTM, in accordance with some embodiments of the present disclosure.

In an embodiment, the CU-CP 206 informs the source DU 202 the active Downlink Bandwidth Part (BWP) and uplink BWP of the target cell at the time of cell switch using F1AP message.

In an embodiment, the source DU 202 includes the DL and UL BWP in MAC CE and sends to the UE 122 for triggering LTM cell switch.

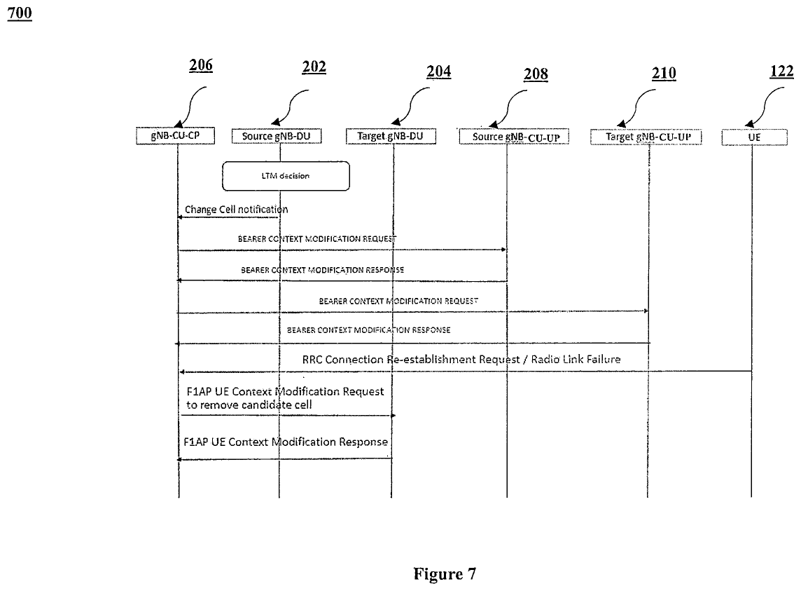

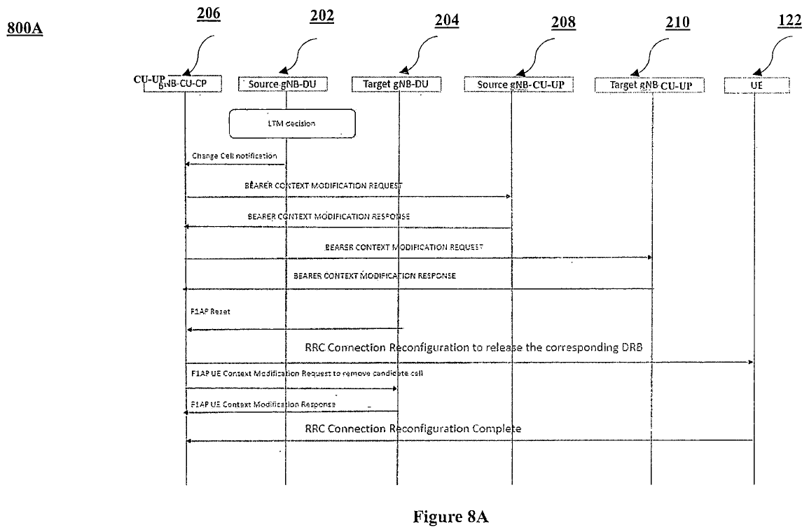

FIG. 7 illustrates a sequence diagram 700 illustrating RRC Connection Reestablishment/Radio Link Failure (RLF) handling with LTM, in accordance with some embodiments of the present disclosure.

The UE 122 declares a Radio Link Failure, on at least one of the following conditions: (i) Expiry of a timer started upon triggering a measurement report for a measurement identity for which the timer has been configured while another radio problem timer is running; or Random access procedure failure; or RLC failure.

In case of LTM, for RLF in the source cell, the UE selects a suitable cell and if the selected cell is an LTM candidate cell and if network configured the UE to try LTM after RLF then the UE attempts RACH-based LTM execution once, otherwise re-establishment is performed.

In an embodiment, upon receiving RRC Reestablishment from UE 122 or RLF indication from the source DU 202, CU-CP 206 clears the reference configuration and all the candidate cell configuration for the UE 122.

In particular as illustrated in FIG. 7, after an LTM decision is made by the source DU 202, a cell change notification is transmitted from the source DU 202 to the CU-CP 206. Thereafter, the CU-CP transmits a bearer context modification request to both the source CU-UP 208 and the target CU-UP 210. In response, each of the source CU-UP 208 and the target CU-UP 210 then transmits a bearer context modification response. Further on detection of RRC Reestablishment or RLF, CU-CP 206 transmits to the target DU 204, an F1AP UE context modification request to remove candidate cell and in response target DU 204 transmits to the CU-CP 206, a F1AP UE context modification response. In an embodiment, CU-CP 206 informs the source DU 202 the activation status of SCell of the target cell at the time of cell switch. In an embodiment, the source DU 202 includes the activation status and the information to identify the SCell such as SCell identity in MAC CE send to the UE 122 for triggering LTM cell switch. If there is no activation status included in the MAC CE, the activation status of the SCell remains the same as before cell switch. If there is no activation status included in the MAC CE, the activation status of the SCell is activated.

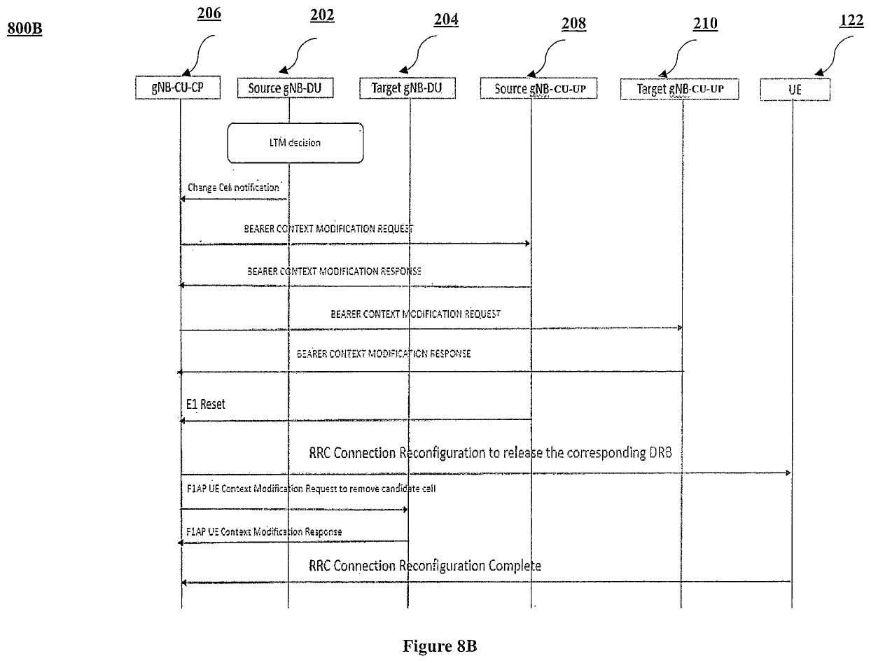

FIG. 8A shows a sequence diagram illustrating a first scenario for Handling F1, Application Protocol (F1AP) Reset during LTM, in accordance with some embodiments of the present disclosure.

In the event of a failure at the target DU 204, which has resulted in the loss of some or all transaction reference information, a RESET message is sent to the CU-CP 206. An F1AP reset message is sent on the F1-C interface between the CU-CP 206 and a target DU 204.

In FIG. 8A, after an LTM decision is made by the source DU 202, the source DU 202 transmits to the CU-CP 206, a cell change notification. Thereafter, the CU-CP 206 transmits a bearer context modification request to both the source CU-UP 208 and the target CU-UP 210. In response, each of the source CU-UP 208 and the target CU-UP 210 then transmits a bearer context modification response. On reception of the RESET message, at the CU-CP 206, the CU-CP 206 transmits an RRC connection reconfiguration to the UE 122 to release all allocated resources on F1 interface related to the UE association(s) and remove the F1AP ID for the indicated UE associations. The RRC connection reconfiguration also facilitates the release of the corresponding DRB of the UE 122. Further, the CU-CP 206 transmits to the target DU 204, an F1AP UE context modification request to remove candidate cell and in response the target DU 204 transmits to the CU-CP 206, an F1AP UE context modification response and thereafter UE 122 transmits to the CU-CP 206, an RRC connection reconfiguration complete message.

In an embodiment, upon receiving an F1AP Reset message from the target DU 204 which contains one or more LTM candidate cells, CU-CP 206 releases the LTM candidate configuration for all LTM candidate cells.

FIG. 8B shows a sequence diagram illustrating a second scenario for Handling E1AP Reset during LTM, in accordance with some embodiments of the present disclosure. E1 interface is point-to-point interface between a CU-CP and gNB-CU-UPs as shown in FIG. 1. The interface supports the exchange of signaling information between said endpoints.

In FIG. 8B, after an LTM decision is made by the source DU 202, the source DU 202 transmits to the CU-CP 206, a cell change notification. Thereafter, the CU-CP 206 transmits a bearer context modification request to both the source CU-UP 208 and the target CU-UP 210. In response, each of the source CU-UP 208 and the target CU-UP 210 then transmits a bearer context modification response. On reception of the RESET message, at the CU-CP 206, the CU-CP 206 transmits an RRC-connection reconfiguration to the UE 122 to release all allocated resources on El interface related to the UE association(s) and remove the F1AP ID for the indicated UE associations. The RRC connection reconfiguration facilitates the release of the corresponding DRB of the UE. Further, the CU-CP 206 transmits to the target DU 204, an F1AP UE context modification request to remove candidate cell and in response the target DU 204 transmits to the CU-CP 206, an F1AP UE context modification response and thereafter UE 122 transmits to the CU-CP 206, an RRC connection reconfiguration complete message.

In an embodiment, upon receiving an E1AP Reset message from the source CU-UP 208 for one or more LTM candidate cells, CU-CP 206 release the LTM candidate configuration for all LTM candidate cells.

In an alternate embodiment, CU-CP 206 selects a new CU-UP and sends E1AP Bearer Context Setup Request to the same. If the CU-CP 206 receives successful response to at least one E1AP bearer, the CU-CP 206 may keep the LTM candidate cell configurations, otherwise the CU-CP 206 release the LTM candidate configuration for those LTM candidate cells.

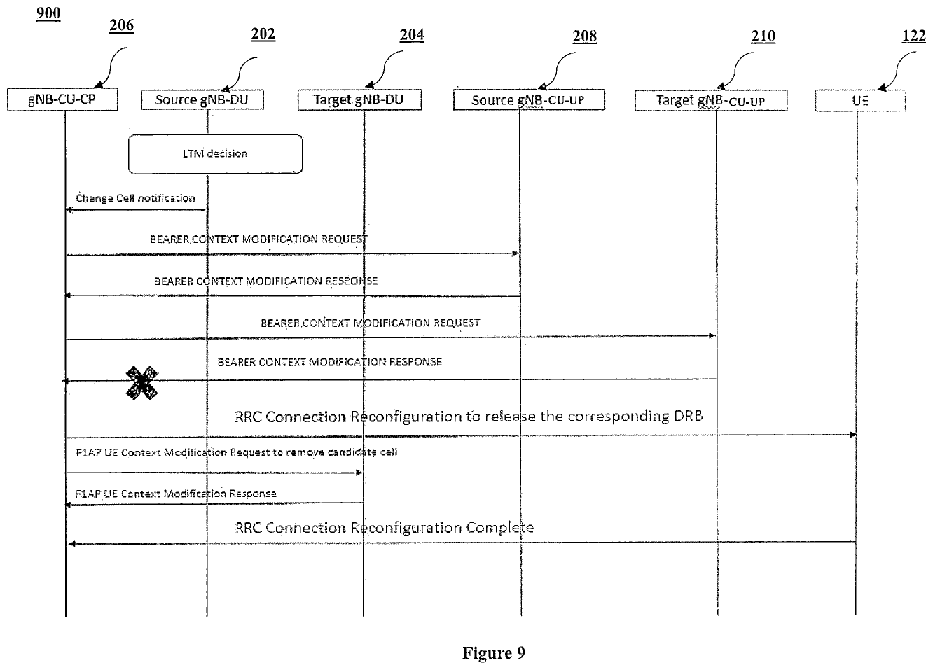

FIG. 9 illustrates a sequence diagram 900 illustrating Handling Bearer Modification Failure during LTM, in accordance with some embodiments of the present disclosure.

In FIG. 9, after an LTM decision is made by the source DU 202, the source DU 202 transmits to the CU-CP 206, a cell change notification. Thereafter, the CU-CP 206 transmits a bearer context modification request to both the source CU-UP 208 and the target CU-UP 210. In response, each of the source CU-UP 208 and the target CU-UP 210 then transmits a bearer context modification response. However, if the bearer Context Modification Request message sent to target CU-UP-210 receives unsuccessful response or if there is a timeout, CU-CP 206 sends an RRC Reconfiguration message to release the corresponding DRB. The CU-CP 206 also sends F1AP Modification Request to release the bearers to the target DU 204, to which cell switch is done. In response, the target DU 204 sends to the CU-CP 206, an F1AP UE context modification response and thereafter the UE 122 sends to the CU-CP 206, an RRC connection reconfiguration message is sent.

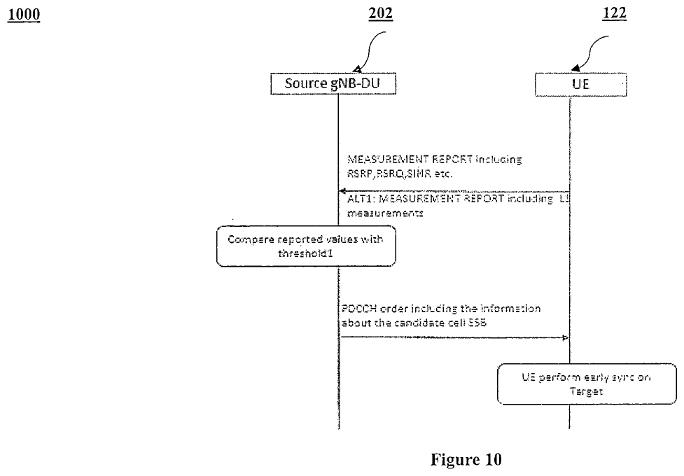

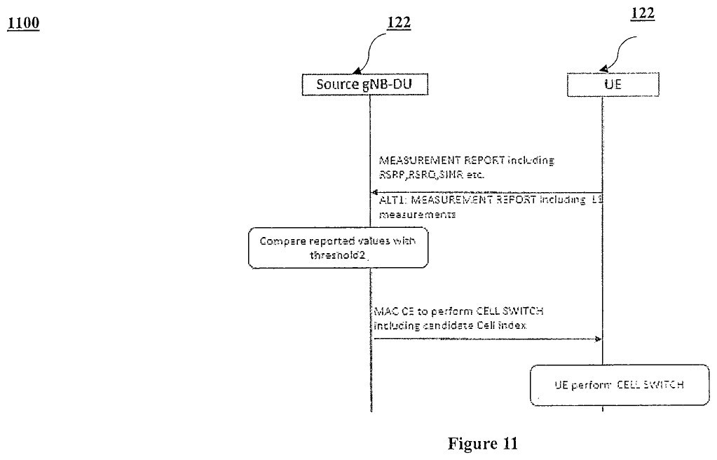

FIG. 10 illustrates a sequence diagram 1000 illustrating a first scenario for Early Sync RACH, in accordance with some embodiments of the present disclosure.

The CU-CP 206 informs the source DU 202 the list of LTM candidate cells including the candidate cell identifier and the PCI. DU receives the LTM measurements (L1 measurements including one of RSRP, RSRQ and SINR) from the UE.

The source DU 202 maintains a first threshold for the LTM measurements for early sync. If the reported value of RSRP (or RSRQ or SINR) is greater than the first threshold, the source DU 202 instructs the UE 122 to perform early sync on the candidate cell by sending the PDCCH order including the information about the candidate cell. In some embodiments, when the UE 122 reports both source cell and candidate cell measurements and if the reported value of RSRP (or RSRQ or SINR) of candidate cell 120 is greater than the first threshold for candidate cell 120 and the reported value of RSRP (or RSRQ or SINR) of source cell 118 is lesser than the first threshold for candidate cell 120, the source DU 202 may instruct the UE 122 to perform early sync on the candidate cell by sending the PDCCH order including the information about the candidate cell. Alternatively, when the UE reports both source cell and candidate cell measurements and if the reported value of RSRP (or RSRQ or SINR) of candidate cell 120 is greater than the reported value of RSRP (or RSRQ or SINR) of source cell by a first offset value, the source DU 202 may instruct the UE 122 to perform early sync on the candidate cell 120 by sending the PDCCH order including the information about the candidate cell 120. The information indicated may be the LTM candidate cell index. Alternatively, the source DU 202 may instruct the UE 122 to perform early sync on the candidate cell 120 by sending the PDCCH order including the information about the candidate cell based on its internal measurements of the UE 122 (UL L1 measurements) or its information about the topology.

The source DU 202 includes the candidate cell SSB as the candidate cell SSB whose L1 measurements are the highest (largest RSRP value or largest RSRQ value or largest SINR value) in the PDCCH order.

FIG. 11 illustrates a sequence diagram 1100 illustrating a second scenario for Early Sync RACH, in accordance with some embodiments of the present disclosure.

In one of the embodiments, the DU is a source DU 202. CU-CP 206 informs the source DU 202 about the list of LTM candidate cells including the candidate cell identifier and the PCI. DU receives the LTM measurements (L1 measurements including. one of Reference Signal Received Power (RSRP), Reference Signal Received Quality (RSRQ), signal-to-interference-plus-noise ratio (SINR) etc.) from the UE.

In an embodiment, the source DU 202 maintains a second threshold for the LTM measurements. If the reported value of RSRP (or RSRQ or SINR etc.) is greater than the second threshold, the source DU 202 instructs the UE 122 to perform cell switch by sending the MAC CE (LTM MAC CE or Cell Switch MAC CE) including the information about the candidate cell. The information indicated may be the LTM candidate cell index.

In some embodiments, when the UE reports both source cell and candidate cell measurements and if the reported value of RSRP (or RSRQ or SINR) of candidate cell 120 is greater than the second threshold for candidate cell 120 and the reported value of RSRP (or RSRQ or SINR) of source cell 118 is lesser than the second threshold for candidate cell 120, the source DU 202 may instruct the UE 122 to perform LTM cell switch Alternatively, if the UE 122 reports both source cell and candidate cell measurements, if the reported value of RSRP (or RSRQ or SINR) of candidate cell is greater than the reported value of RSRP (or RSRQ or SINR) of source cell by a second offset value, the source DU 202 may instruct the UE 122 to perform LTM cell switch.

In an embodiment, the source DU 202 selects UL/SUL for performing random access based on the received LTM measurements. For e.g., if the RSRP value (or RSRQ or SINR value, whichever is considered) for the cell switch is higher in SUL, the source DU 202 includes SUL in the MAC CE sent for triggering cell switch. Similarly, if the RSRP value (or RSRQ or SINR value, whichever is considered) for the cell switch is higher in UL source DU 202 includes UL in the MAC CE send for triggering cell switch.

In an embodiment, the first threshold and the second threshold have two different threshold values. In an alternative embodiment, the first threshold and the second threshold have a common threshold value.

In an embodiment, the first offset and the second offset have two different offset values. In an alternative embodiment, the first offset and the second offset have a common threshold value.

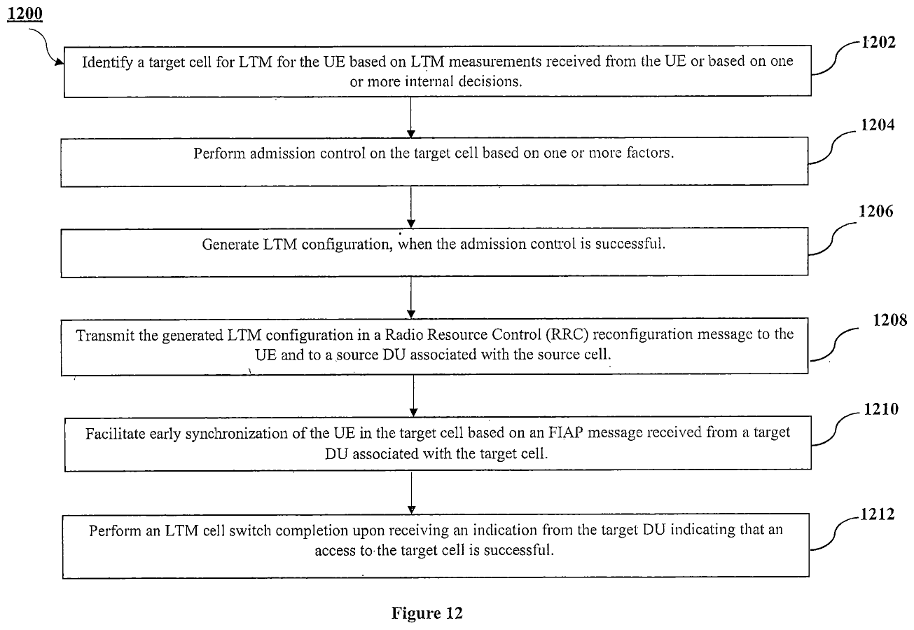

FIG. 12 illustrates a flow chart 1200 illustrating a method performed by a base station 106 for implementing LTM when performing a cell switch procedure, in accordance with some embodiments of the present disclosure.

In one embodiment of the present disclosure, a method 1200 for implementing Lower Layers Triggered mobility (LTM) when performing a cell switch procedure of a User Equipment (UE) from the source cell 118 to the target cell 122 served by the base station (gNB) 106, is disclosed. The gNB 106 comprising a Centralized Unit (CU) 108, and one or more Distributed Units (DUs) for serving the UE 122. The one or more DUs comprise a source DU 202 and a target DU 204.

The method 1200 comprises at block 1202 identifying by the base station 106 (specifically, by the CU 108), the target cell 120 for LTM for the UE 122 based on measurements received from the UE 122 or based on one or more internal decisions and thereafter at block 1204 performing, by the base station 106 (specifically, by the CU 108), admission control on the target cell 120 based on one or more factors.

In one of the embodiments, the one or more factors comprise a number of UEs associated with a neighbor cell for which LTM is triggered, a number of RRC_CONNECTED UEs in the target cell 120, a number of UEs associated with the neighbor cell which are configured for a conditional handover.

The performing the admission control on the target cell 120 comprises performing one or more of: configuring the cell as LTM candidate cell when the number of UEs associated with the cell for which LTM is triggered is less than a first threshold; configuring the cell as LTM candidate cell when a sum of the number of RRC_CONNECTED UEs and the number of UEs associated with the cell for which LTM is triggered is less than a second threshold; and configuring the cell as LTM candidate cell when a sum of the number of RRC_CONNECTED UEs and the number of UEs associated with the cell which are configured for the conditional handover and the number of UEs associated with the cell for which LTM is triggered is less than a third threshold.

The method 1200 further comprises at block 1206 generating, by the base station 106 (specifically, by the CU 108), LTM configuration, when the admission control is successful. The LTM configuration comprises at least one of a complete LTM candidate configuration; and a non-complete LTM candidate configuration and an LTM reference configuration. The LTM reference configuration is based on at least one of a cell group configuration associated with the source cell 118 and a cell group configuration associated with the target cell 120, along with a Layer 3 configuration associated with the CU.

The method 1200 further comprises, at block 1208 transmitting, by the base station 106 (specifically, by the CU 108), the generated LTM configuration to the UE 122 in a Radio Resource Control (RRC) reconfiguration message and to the source DU 202 associated with the source cell 118. The RRC reconfiguration message to the source DU 202 is transmitted in an F1 Application Protocol (F1AP) message.

The method 1200 further comprises, at block 1210 facilitating, by the base station 106 (specifically, by the CU 108), early synchronization of the UE 122 in the target cell 120 based on an F1AP message received from the target DU 204 associated with the target cell 120.

In one of the embodiments, the method comprises transmitting, by the source DU 202, order for triggering or re-triggering the UE 122 to perform early synchronization on the target cell 120, when the timing advance value is not communicated by the target DU 204 to the source DU 202. In one of the embodiments, based on identifying, by the target DU 204, whether an early synchronization has occurred in the UE, initiating by the target DU 204, a timing advance (TA) timer; and upon receiving indication regarding the cell switch procedure, resetting by the target DU 204, the TA timer.

In one of the embodiments, facilitating the early synchronization of the UE 122 in the target cell 120 comprises: receiving, from the target DU 204, the F1AP message comprising an LTM candidate cell identifier and a timing advance value; and transmitting the LTM candidate cell identifier and the timing advance value to the source DU 202 associated with the source cell 118. In one of the embodiments, facilitating the early synchronization of the UE 122 in the candidate cell comprises receiving, from the source DU, information comprising an LTM candidate cell identifier and a timing advance value. The source DU 202 receives the information from the target DU 204, via an inter-DU interface.

The method 1200 further comprises at block 1212 performing, by the base station 106 (specifically, by the CU 108), an LTM cell switch completion upon receiving an indication from the target DU 204 indicating that an access to the target cell 120 is successful. In another embodiment, the Layer 3 configuration comprises a measurement configuration and a radio bearer configuration.

In one of the embodiments, the method 1200 further comprises performing, by the source DU 202 associated with the source cell 118, operations of: receiving LTM measurements from the UE. The LTM measurements comprise Layer 1 measurements comprising information associated with at least one of Reference signal received power (RSRP), Reference Signal Received Quality (RSRQ), and Signal-to-Interference-plus-Noise Ratio (SINR). Based on whether the received LTM measurements meet a first threshold, the source DU 202 further performs transmitting a Physical Downlink Control Channel (PDCCH) order comprising information regarding the target cell 120 for triggering the UE 122 to perform early synchronization on the target cell 120. The information regarding the target cell 120 comprises an LTM candidate cell index.

In some embodiments, when the UE 122 reports both source cell and candidate cell measurements and if the reported value of RSRP (or RSRQ or SINR) of candidate cell 120 is greater than the first threshold for candidate cell 120 and the reported value of RSRP (or RSRQ or SINR) of source cell 118 is lesser than the first threshold for candidate cell 120, the source DU 202 may instruct the UE 122 to perform early sync on the candidate cell by sending the PDCCH order including the information about the candidate cell. Alternatively, when the UE reports both source cell and candidate cell measurements and if the reported value of RSRP (or RSRQ or SINR) of candidate cell 120 is greater than the reported value of RSRP (or RSRQ or SINR) of source cell by a first offset value, the source DU 202 may instruct the UE 122 to perform early sync on the candidate cell 120 by sending the PDCCH order including the information about the candidate cell 120. The information indicated may be the LTM candidate cell index.

Alternatively, the source DU 202 may instruct the UE 122 to perform early sync on the candidate cell 120 by sending the PDCCH order including the information about the candidate cell based on its internal measurements of the UE 122 (UL L1 measurements) or its information about the topology.

In an embodiment, the source DU 202 maintains a second threshold for the LTM measurements. Further, the source DU 202 based on whether the received LTM measurements meets the second threshold, transmits a MAC Control Element (MAC CE) comprising information regarding the target cell 120 for triggering the UE 122 to perform cell switch, wherein the information regarding target cell 120 comprises an LTM candidate cell index.

In an embodiment, if the reported value of RSRP (or RSRQ or SINR etc.) is greater than the second threshold, the source DU 202 instructs the UE 122 to perform cell switch by sending the MAC CE (LTM MAC CE or Cell Switch MAC CE) including the information about the candidate cell. The information indicated may be the LTM candidate cell index.

In some embodiments, when the UE 122 reports both source cell and candidate cell measurements and if the reported value of RSRP (or RSRQ or SINR) of candidate cell 120 is greater than the second threshold for candidate cell 120 and the reported value of RSRP (or RSRQ or SINR) of source cell 118 is lesser than the second threshold for candidate cell 120, the source DU 202 may instruct the UE 122 to perform LTM cell switch Alternatively, if the UE 122 reports both source cell and candidate cell measurements, if the reported value of RSRP (or RSRQ or SINR) of candidate cell is greater than the reported value of RSRP (or RSRQ or SINR) of source cell by a. second offset value, the source DU 202 may instruct the UE 122 to perform LTM cell switch.

In an embodiment, the first threshold and the second threshold have two different threshold values. In an alternative embodiment, the first threshold and the second threshold have a common threshold value.

In an embodiment, the first offset and the second offset have two different offset values. In an alternative embodiment, the first offset and the second offset have a common threshold value.

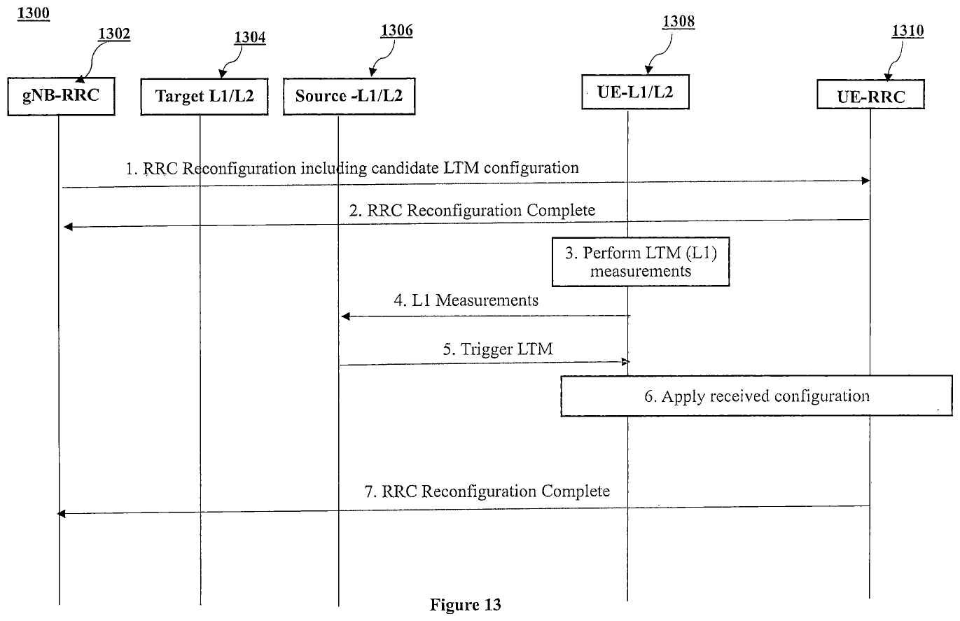

FIG. 13 illustrates an exemplary sequence diagram 1300 illustrating a basic flow of LTM, in accordance with the embodiments of the present disclosure. The 5G New Radio (NR) physical layer OR Layer 1 acts as the foundation for seamless communication by transforming data into radio signals and vice versa. The Layer 2 of New Radio (NR) is split into the following sublayers: Medium Access Control (MAC), Radio Link Control (RLC), Packet Data Convergence Protocol (PDCP) and Service Data Adaptation Protocol (SDAP). The physical layer offers to the MAC sublayer transport channel. The MAC sublayer offers to the RLC sublayer logical channels. The RLC sublayer offers to the PDCP sublayer RLC channels. The PDCP sublayer offers to the SDAP sublayer radio bearers. The RRC layer or Layer 3 broadcasts essential network information to both the Non-Access Stratum (NAS) and Access Stratum (AS), for efficient communication.

Layer 3 mobility requires reconfiguration of upper layers (e.g., RRC or PDCP) and/or resetting of lower layers (e.g., MAC and/or PHY), while in L1/L2 mobility the, configuration of the upper layers is maintained and changes to configuration of the lower layers are minimized.

FIG. 13 illustrates LTM at the various layers. At the RRC layer, in step 1 of FIG. 13, RRC reconfiguration including candidate LTM configuration is transmitted from the gNB 106 to the UE 122. The RRC layer of gNB 106 may be referred as 1302. At step 2 of FIG. 13, the RRC reconfiguration complete indication is transmitted from the UE 122 to gNB 106. The RRC layer of UE 122 may be referred as 1310. At layers 1 and 2, L1 measurements are performed at the UE 122 (step 3) and thereafter transmitted to source DU 202. The layers 1 and 2 of UE 122 is referred as 1308 and layers 1 and 2 of source DU 202 is referred as 1306. Further at step 5, LTM is triggered at UE 122 based on the L1 measurements. At step 6, the received LTM configuration is applied by the UE 122 and thereafter at step 7, RRC reconfiguration complete indication is transmitted from the UE 122 to gNB 106.

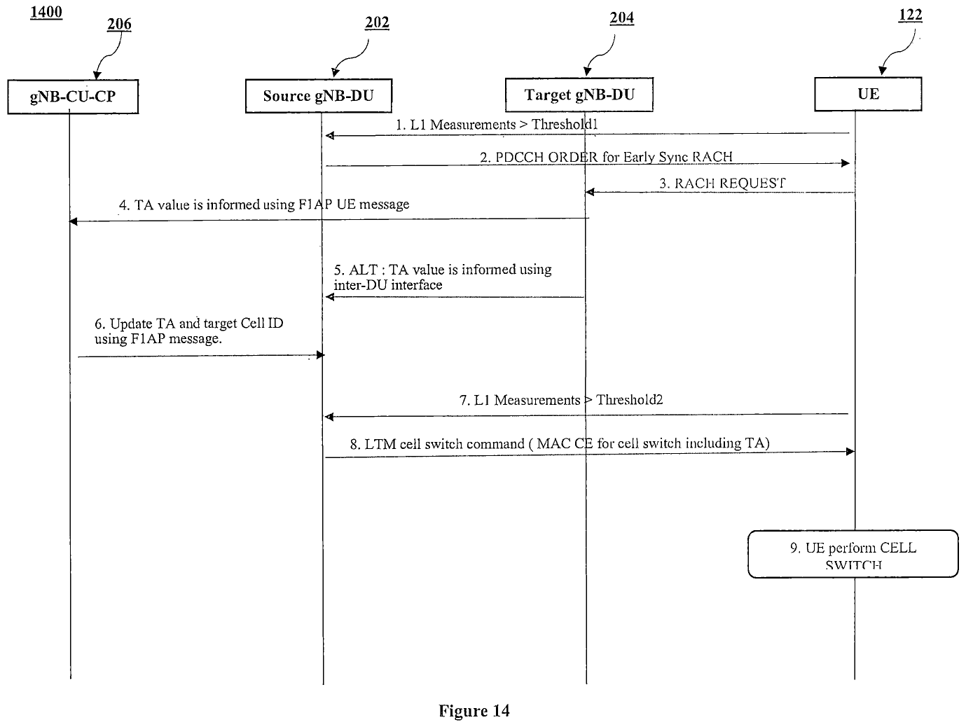

FIG. 14 illustrates a sequence diagram 1400 illustrating a third scenario for Early Sync RACH similar to FIGS. 5C, 10-11, in accordance with some embodiments of the present disclosure.

Similar to the steps illustrated in FIG. 5C, in FIG. 14, at step 1 measurement values reported by UE 122 are compared with a first threshold, and PDDCH order to trigger early sync is transmitted to UE 122 based on the comparison (step 2). At step 3, a RACH request is transmitted by UE 122 to target-DU 204. At step 4, the timing advance value is informed using a F1AP UE message to CU-CP 206. In an alternate embodiment at step 5, the timing advance value is informed using inter-DU interface to source DU 202. At step 6, timing advance and target cell ID is updated and transmitted to F1AP message. Further in FIG. 14, measurement values reported by UE 122 are also compared with a second threshold (step 7) as done in FIG. 11. Thereafter at step 8, an LTM cell switch command is transmitted to UE 122, and at step 9, the UE performs the cell switch.

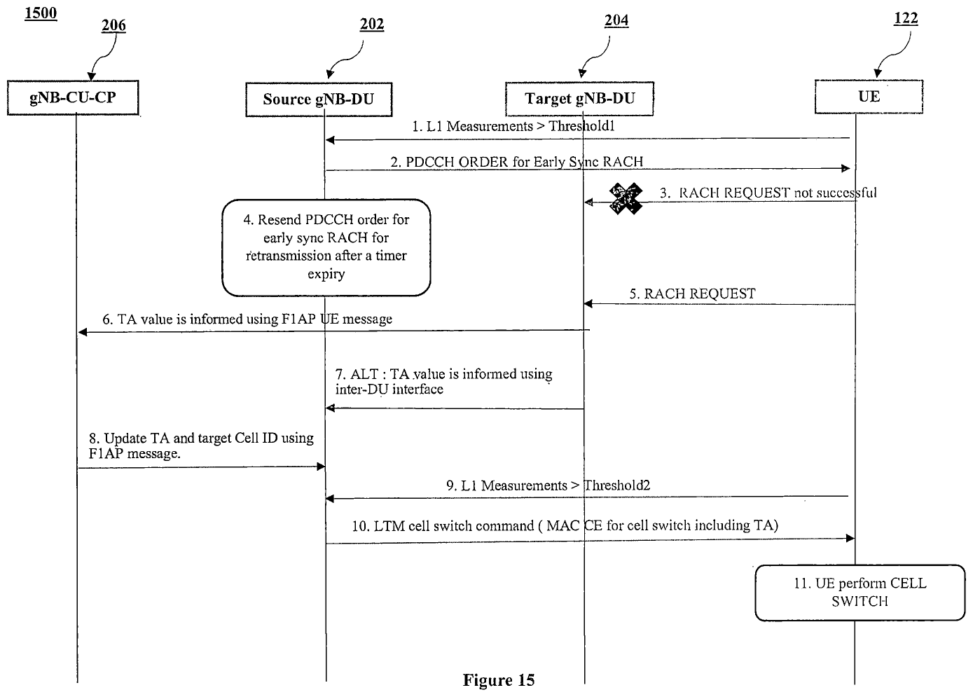

FIG. 15 illustrates a sequence diagram 1500 illustrating a fourth scenario for Early Sync RACH similar to FIG. 14, in accordance with some embodiments of the present disclosure.

Similar to the steps illustrated in FIG. 14, in FIG. 15 at step 1 measurement values reported by UE 122 are compared with a first threshold, and PDDCH order to trigger early sync is transmitted to UE 122 based on the comparison (step 2). However, as illustrated in FIG. 15, at step 3, a RACH request transmitted by UE 122, may not be successfully received by the target-DU 204. Thus, at step 4, the PDDCH order to trigger early sync is re-transmitted to UE 122, after expiry of a timer. At step 5, a RACH request retransmitted by UE 122. The steps 6-11 of FIG. 15 are same as that of steps 4-9 of. FIG. 14.

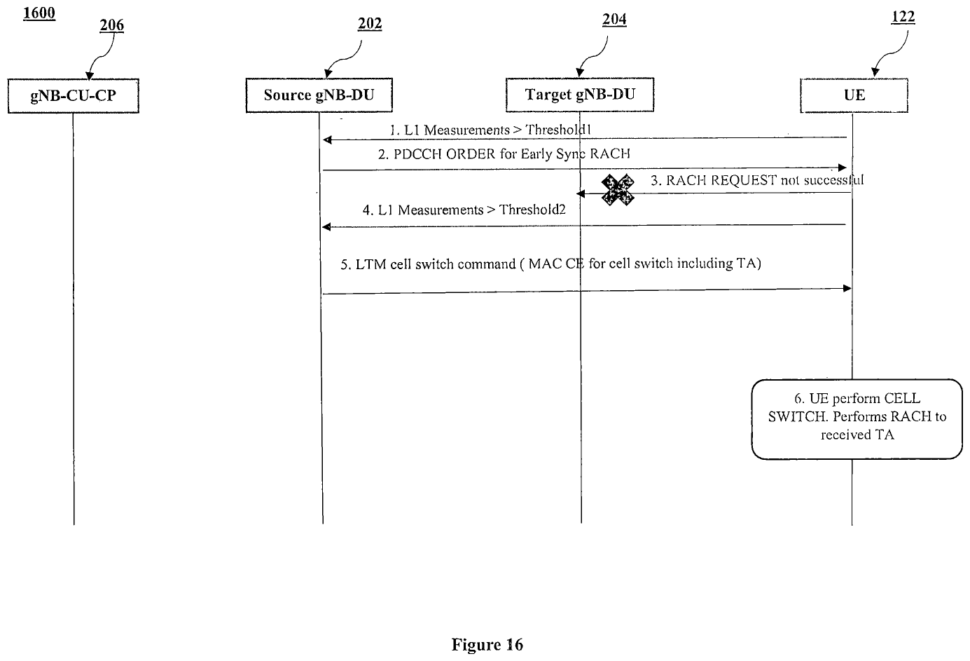

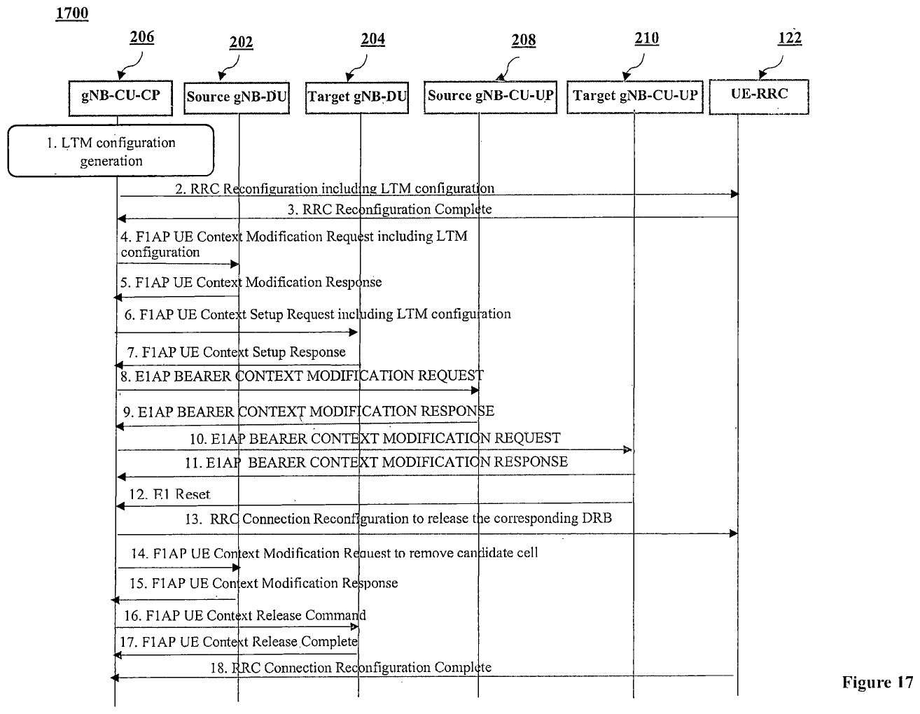

FIG. 16 illustrates a sequence diagram 1500 illustrating a fifth scenario for Early Sync RACH similar to FIG. 15, in accordance with some embodiments of the present disclosure. Similar to the steps illustrated in FIG. 15, in FIG. 16 at step 1 measurement values reported by UE 122 are compared with a first threshold, and PDDCH order to trigger early sync is transmitted to UE 122 based on the comparison (step 2). However, as illustrated in FIG. 16, at step 3, a RACH request transmitted by UE 122, may not be successfully received by the target-DU 204. In the embodiment of FIG. 15, in such scenario, a PDDCH order to trigger early sync is re-transmitted to UE 122. However, in FIG. 16, despite successful reception of RACH request, the measurement values reported by UE 122 are directly compared with a second threshold (step 4). Thereafter at step 5, an LTM cell switch command is transmitted to UE 122, and at step 9, the UE performs the cell switch and then performs the RACH request to receive Timing Advance value.

FIG. 17 shows a sequence diagram illustrating a scenario for Handling E1 Reset during LTM similar to FIGS. 8A-8B, in accordance with some embodiments of the present disclosure. The steps of FIG. 17 are similar to those illustrated in FIG. 8B. However, FIG. 17 consists of additional steps 4-7 and steps 16-17. At step 4, F1AP UE context modification request including the LTM configuration is transmitted to source DU 202 and at step 5, the source DU 202 transmits F1AP UE context modification response. At step 6, F1AP UE context setup request including the LTM configuration is transmitted to target DU 204 and at step 7, the target DU 204 transmits F1AP UE context setup response. Further at step 16, the CU-CP 206 transmits to the target DU 204, an F1AP UE context release command and in response the target DU 204 transmits to the CU-CP 206, an F1AP UE context release complete.

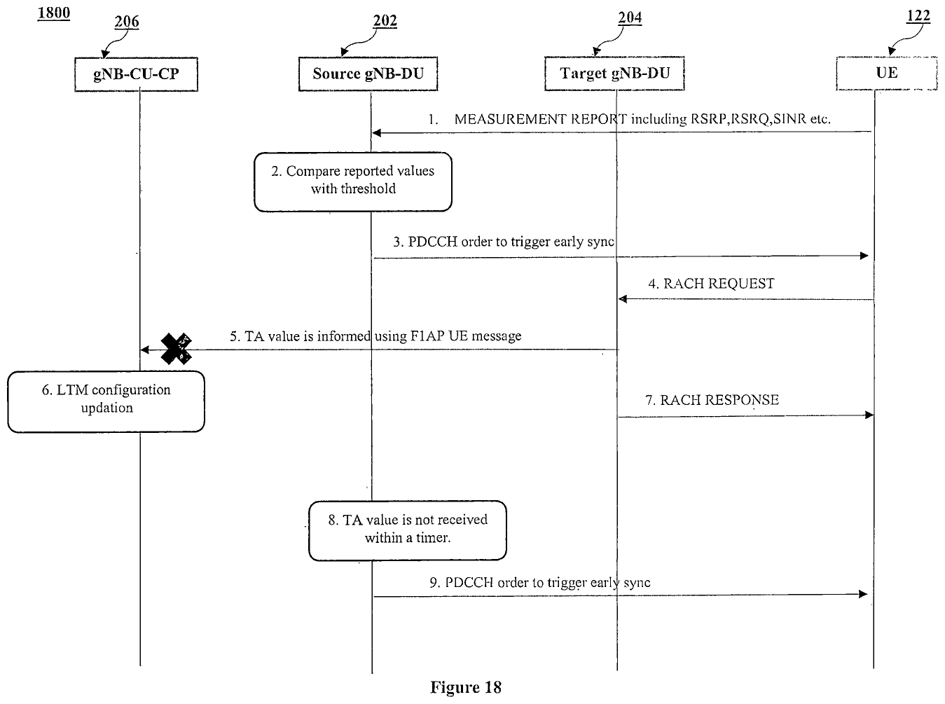

FIG. 18 shows sequence diagram illustrating a scenario of Early Sync Random Access Channel (RACH) in LTM similar to that illustrated in FIG. 5C in accordance with the embodiments of the present disclosure. The steps 1-4 of FIG. 18 are same as that of steps 1-4 of FIG. 5C. However, as illustrated in FIG. 5, the target DU 204 fails to inform the timing advance value to CU-CP 206. Thus, the Timing advance value is not received by the source DU 202 (step 8), and a PDDCH order to trigger early sync is re-transmitted to UE 122.

The embodiments disclosed herein can be implemented through at least one software program running on at least one hardware device and performing network management functions to control the elements. The elements can be at least one of a hardware device, or a combination of hardware device and software module. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method (1200) performed by a base station (106) for implementing Lower Layers Triggered mobility (LTM) when performing a cell switch procedure of a User Equipment (UE) (122) from a source cell (118) to a target cell (120) served by the base station (106), the method (1200) comprising:
identifying (1202) the target cell (120) for LTM for the UE (122) based on LTM measurements received from the UE (122) or based on one or more internal decisions;
performing (1204) admission control on the target cell (120) based on one or more factors;
generating (1206) LTM configuration, when the admission control is successful;
transmitting (1208) the generated LTM configuration to the UE (122) in a Radio Resource Control (RRC) reconfiguration message and to a source Distributed Unit (DU) (202) associated with the source cell (118);
facilitating (1210) early synchronization of the UE (122) in the target cell (120) based on an F1 Application Protocol (F1AP ) message received from a target DU (204) associated with the target cell (120); and
performing (1212) an LTM cell switch completion upon receiving an indication from the target DU (204) indicating that an access to the target cell (120) is successful.

2. The method as claimed in claim 1, wherein the LTM configuration comprises at least one of:
a complete LTM candidate configuration; and
a non-complete LTM candidate configuration and an LTM reference configuration,
wherein the LTM reference configuration is based on at least one of a cell group configuration associated with the source cell and a cell group configuration associated with the target cell, along with a Layer 3 configuration, and wherein the Layer 3 configuration comprises a measurement configuration and a radio bearer configuration.

3. The method as claimed in claim 1, wherein the one or more factors comprise a number of UEs associated with a neighbor cell for which LTM is triggered, a number of RRC_CONNECTED UEs in the target cell, a number of UEs associated with the neighbor cell which are configured for a conditional handover, and wherein performing the admission control on the target cell comprises performing one or more of:
configuring the target cell as LTM candidate cell when the number of UEs associated with the cell for which LTM is triggered is less than a first threshold;
configuring the cell as LTM candidate cell when a sum of the number of RRC_CONNECTED UEs and the number of UEs associated with the cell for which LTM is triggered is less than a second threshold; and
configuring the cell as LTM candidate cell when a sum of the number of RRC_CONNECTED UEs and the number of UEs associated with the cell which are configured for the conditional handover and the number of UEs associated with the cell for which LTM is triggered is less than a third threshold.

4. The method as claimed in claim 1, wherein facilitating the early synchronization of the UE in the target cell comprises:
receiving, by a Centralized Unit (CU) of the base station from the target DU, the F1AP message comprising an LTM candidate cell identifier and a timing advance value; and
transmitting the LTM candidate cell identifier and the timing advance value to the source DU associated with the source cell.

5. The method as claimed in claim 4, further comprising transmitting a Physical Downlink Control Channel (PDCCH) order for triggering or retriggering the UE to perform early synchronization on the target cell, when the timing advance value is not communicated by the target DU to the source DU.

6. The method as claimed in claim 1, wherein the base station comprises a Centralized Unit (CU) and one or more DUs for serving the UE, wherein the CU includes a centralized unit control-plane (CU-CP) and at least one centralized unit user-plane (CU-UP), and wherein the one or more DUs comprise the source DU and the target DU which are coupled to the at least one CU-UP for serving the UE.

7. The method as claimed in claim 1, further comprises performing operations of:
receiving the LTM measurements from the UE, wherein the LTM measurements comprise Layer 1 measurements comprising information associated with at least one of Reference signal received power (RSRP), Reference Signal Received Quality (RSRQ), and Signal-to-Interference-plus-Noise Ratio (SINR);
based on determining that the received LTM measurements meet a first threshold, transmitting a Physical Downlink Control Channel (PDCCH) order comprising information regarding the target cell for triggering the UE to perform early synchronization on the target cell, wherein the information regarding target cell comprises. _ an LTM candidate cell index; and
based on determining that the received LTM measurements meet a second threshold, transmitting a MAC Control Element (MAC CE) comprising information regarding the target cell for triggering the UE to perform cell switch, wherein the information regarding target cell comprises an LTM candidate cell index.

8. The method as claimed in claim 1, further comprising:
based on identifying whether an early synchronization has occurred in the UE, initiating a timing advance (TA) timer; and
upon receiving indication regarding the cell switch procedure, resetting the TA timer.

9. The method as claimed in claim 1, wherein the one or more internal decisions comprises one or more decisions made by the base station based on a deployment map or a load balancing technique or prediction data received from one or more Machine Learning (ML) models, wherein the RRC reconfiguration message to the source DU is transmitted in an F1AP message.

10. A base station (106) for implementing Lower Layers Triggered mobility (LTM) when performing a cell switch procedure of a User Equipment (UE) (122) from a source cell (118) to a target cell (120) served by the base station (106), wherein the base station (106) is configured to:
identify the target cell (120) for LTM for the UE (122) based on LTM measurements received from the UE (122) or based on one or more internal decisions;
perform admission control on the target cell (120) based on one or more factors;
generate LTM configuration, when the admission control is successful;
transmit the generated LTM configuration to the UE (122) in a Radio Resource Control (RRC) reconfiguration message and to a source Distributed Unit (DU) (202) associated with the source cell (118);
facilitate early synchronization of the UE (122) in the target cell (120) based on an F1 Application Protocol (F1AP) message received from a target DU (204) associated with the target cell (120); and
perform an LTM cell switch completion upon receiving an indication from the target DU (204) indicating that an access to the target cell (120) is successful.

11. The base station as claimed in claim 10, wherein the LTM configuration comprises at least one of:
a complete LTM candidate configuration; and
a non-complete LTM candidate configuration and an LTM reference configuration,
wherein the LTM reference configuration is based on at least one of a cell group configuration associated with the source cell and a cell group configuration associated with the target cell, along with a Layer 3 configuration, and wherein the Layer 3 configuration comprises a measurement configuration and a radio bearer configuration.

12. The base station as claimed in claim 10, wherein the one or more factors comprise a number of UEs associated with a neighbor cell for which LTM is triggered, a number of RRC_CONNECTED UEs in the target cell, a number of UEs associated with the target cell which are configured for a conditional handover, and wherein to perform the admission control on the target cell, the base station is adapted to:
configure the target cell when the number of UEs associated with the target cell for which LTM is triggered is less than a first threshold;
configure the target cell when a sum of the number of RRC_CONNECTED UEs and the number of UEs associated with the target cell for which LTM is triggered is less than a second threshold; and
configure the target cell when a sum of the number of RRC_CONNECTED UEs and the number of UEs associated with the target cell which are configured for the conditional handover and the number of UEs associated with the target cell for which LTM is triggered is less than a third threshold.

13. The base station as claimed in claim 10, wherein to facilitate the early synchronization, the base station is configured to:
receive, via a Centralized Unit (CU) of the base station from the target DU, the F1AP message comprising an LTM target cell identifier and a timing advance value; and
transmit, the LTM target cell identifier and the timing advance value to the source DU associated with the source cell.

14. The base station as claimed in claim 13, wherein the base station is further configured to transmit a Physical Downlink Control Channel (PDCCH) order for triggering or re-triggering the UE to perform early synchronization on the target cell, when the timing advance value is not communicated by the target DU to the source DU.

15. The base station as claimed in claim 10, wherein the base station comprises a Centralized Unit (CU) and one or more DUs for serving the UE, wherein the CU includes a centralized unit control-plane (CU-CP) and at least one centralized unit user-plane (CU-UP), and wherein the one or more DUs comprise the source DU and the target DU which are coupled to the at least one CU-UP for serving the UE.

16. The base station as claimed in claim 10, wherein the base station is further configured to:
receive the LTM measurements from the UE, wherein the LTM measurements comprise Layer 1 measurements comprising information associated with at least one of Reference signal received power (RSRP), Reference Signal Received Quality (RSRQ), and Signal-to-Interference-plus-Noise Ratio (SINR);
based on determining that the received LTM measurements meet a first threshold, transmit a Physical Downlink Control Channel (PDCCH) order comprising information regarding the target cell for triggering the UE to perform the early synchronization on the target cell, wherein the information regarding target cell comprises an LTM candidate cell index; and
based on determining that the received LTM measurements meet a second threshold, transmit a MAC Control Element (MAC CE) comprising information regarding the target cell for triggering the UE to perform the cell switch procedure, wherein the information regarding target cell comprises an LTM candidate cell index.

17. The base station as claimed in claim 10, wherein the base station is further configured to:
based on identifying whether an early synchronization has occurred in the UE, initiate a timing advance (TA) timer; and
upon receiving indication regarding the cell switch procedure, reset the TA timer.

18. The base station as claimed in claim 10, wherein the one or more internal decisions comprises one or more decisions made by the base station based on a deployment map or a load balancing technique or prediction data received from one or more Machine Learning (ML) models, and wherein the RRC reconfiguration message to the source DU is transmitted in an F1AP message.
